(19) United States
(12) Patent Application Publication
(10) Pub. No.: US 2012/0099052 A1
(43) Pub. Date: Apr. 26, 2012

(54) RETARDER AND LIQUID CRYSTAL DISPLAY COMPRISING THE SAME

(75) Inventor: Pavel Ivan Lazarev, (US)

(73) Assignee: Crysoptix KK, Tokyo (JP)

(21) Appl. No.: 13/277,213

(22) Filed: Oct. 20, 2011

Related U.S. Application Data
(60) Provisional application No. 61/405,449, filed on Oct. 21, 2010.

(51) Int. Cl. G02F 1/1335; G02B 5/30

(52) U.S. Cl. 349/96; 359/489.07

(57) ABSTRACT

The present invention generally relates to a component of liquid crystal display and more particularly to a retarder that comprises a birefringent material. The disclosed retarder comprises at least one substrate, and a retardation layer coated onto the substrate. The substrate possesses anisotropic property of positive A-type. The retardation layer is substantially transparent to electromagnetic radiation in the visible spectral range, and a principal axis of the lowest refractive index of the retardation layer and the principal axis of the largest refractive index of the substrate are substantially parallel to each other.

### FIELD OF THE INVENTION

The present invention generally relates to the components of liquid crystal display and more particularly to a retarder that comprises a birefringent substrate.

### BACKGROUND OF THE INVENTION

Retarders are used to alter the relative phase of polarized light passing through them, and thus, are well suited for use in applications where control over the polarization is required. For example, optical retarders are used to compensate the phase difference between two components of polarized light which is introduced by other elements of an optical design.

One particularly important application of optical retardation layers is providing polarization compensation for liquid crystal display (LCD) panels.

LCD panels are widely used in watches and clocks, photographic cameras, technical instruments, computers, flat TV, projection screens, control panels and large area of information-providing devices. Information in many LCD panels is presented in the form of a row of numerals or characters, which are generated by a number of segmented electrodes arranged in a pattern. The driving voltage is applied to a combination of segments and controls the light transmitted through this combination of segments. Graphic information can be also realized by a matrix of pixels, which are connected by an X-Y sequential addressing scheme between two sets of perpendicular conductors. More advanced addressing schemes use arrays of thin film transistors to control the drive voltage at the individual pixels. This scheme is applied to in-plane switching mode liquid crystal displays and also to high performance versions of vertically-aligned mode liquid crystal displays.

An ideal display should show equal contrast and colour rendering while being watched under different angles deviating from the normal observation direction. The different kinds of displays based on nematic liquid crystal, however, possess an angle dependence of contrast. It means that at angles deviating from the normal observation direction, the contrast becomes lower and the visibility of the information is diminished. Materials which are commonly used in nematic LCDs are optically positively uniaxially birefringent, which means that an extraordinary refractive index nₑ is larger then the ordinary refractive index nₒ; Δn=nₑ−nₒ>0. Visibility of the displays under oblique angles can be improved by using optical compensators with negative birefringence (Δn<0). The loss of contrast is also caused by light leakage through the black state pixel elements at large viewing angles. In colour liquid crystal displays the leakage also causes severe colour shifts for both saturated and grey scale colours. These limitations are particularly important for displays used for the control panels in aircraft applications where it is important that a co-pilot is viewing the pilot's displays. It would be a significant improvement in the art to provide a liquid crystal display capable of presenting a high quality, high contrast image over a wide field of view.

The chemical compounds used for the compensators should be transparent in the working spectral wavelength range. Most LCD devices are adapted for a human eye, and for these devices the working range is a visible spectral range

Requirements to durability and mechanical strength of all components of LCD are getting higher, especially with development of new application fields of displays. The protecting substrates are used to improve durability and mechanical stability of the polarizer. Triacetyl cellulose (TAC) is widely used as a material of the protecting substrate. This material possesses high transparency and good adhesion to the polarizing plate. At the same time, TAC substrate possesses a number of drawbacks in comparison with other polymer substrates. TAC substrate is a costly component, it has a low mechanical strength and hardness, and high water absorption.

The disclosed retarder possess a higher mechanical strength and hardness, a lower water absorption, and a lower price that the retarders on the market.

### SUMMARY OF THE INVENTION

In a first aspect of the present invention there is provided a retarder comprising at least one substrate, and at least one retardation layer coated onto the substrate. The substrate possesses an anisotropic property of positive A-type and the retardation layer is substantially transparent to electromagnetic radiation in the visible spectral range. A principal axis of the lowest refractive index of the retardation layer and the principal axis of the largest refractive index of the substrate are substantially parallel to each other.

In a second aspect of the present invention there is provided a liquid crystal display comprising a liquid crystal cell, first and second polarizers arranged on each side of the liquid crystal cell, and at least one retarder located between said polarizers. The retarder comprises at least one substrate and at least one retardation layer coated onto the substrate. Said substrate possesses an anisotropic property of positive A-type, the retardation layer is substantially transparent to electromagnetic radiation in the visible spectral range, and a principal axis of the lowest refractive index of the retardation layer and the principal axis of the largest refractive index of the substrate are substantially parallel to each other

### BRIEF DESCRIPTION OF THE DRAWINGS

FIG. 1 shows spectra of principal refractive indices of retardation layer of B_{A}-type.

FIG. 2 shows spectra of in-plane retardation of PP-substrate (1), retardation layer (2) and retarder (3).

FIG. 3 shows viewing angle performance (contrast ratio) for the IPS design at a central wavelength of 550 nm

FIG. 4 POM shows image of triple solution.

### DETAILED DESCRIPTION OF THE INVENTION

The general description of the present invention having been made, a further understanding can be obtained by reference to the specific preferred embodiments, which are given herein only for the purpose of illustration and are not intended to limit the scope of the appended claims.

Definitions of various terms used in the description and claims of the present invention are listed below.

The term “visible spectral range” refers to a spectral range having the lower boundary approximately equal to 400 nm, and upper boundary approximately equal to 750 nm.

The term “retardation layer” refers to an optically anisotropic layer which is characterized by three principal refractive indices (nₓ, n_{y} and n_{z}), wherein two principal directions for refractive indices nₓ and n_{y} belong to xy-plane coinciding with a plane of the retardation layer and one principal direction for refractive index (n_{z}) coincides with a normal line to the retardation layer, and wherein at least two of principal refractive indices are different.

The term “substrate possessing anisotropic property of positive A-type” refers to an uniaxial optic substrate which refractive indices nₓ, n_{y}, and n_{z} obey the following condition in the visible spectral range: n_{z}=n_{y}<nₓ.

The term “retardation plate of negative A-type” refers to an uniaxial optic retardation plate which refractive indices nₓ, n_{y}, and n_{z} obey the following condition in the visible spectral range: nₓ<n_{y}=n_{z}.

The term “retardation plate of negative B_{A}-type” refers to an biaxial optic retardation plate which refractive indices nₓ, n_{y}, and n_{z} obey the following condition in the visible spectral range: nₓ<n_{z}<n_{y}.

The term “thickness retardation Rₜₕ” refers to a retardation of a retardation layer, substrate or plate which is defined with the following expression: Rₜₕ=[n_{z}−(nₓ+n_{y})/2]*d, where d is a thickness of the retardation layer, substrate or plate.

The term “in-plane retardation Rₒ” refers to a retardation of a retardation layer, substrate or plate which is defined with the following expression: Rₒ=(nₓ−n_{y})*d, where d is a thickness of the retardation layer, substrate or plate.

The above mentioned definitions are invariant to rotation of system of coordinates (of the laboratory frame) around of the vertical z-axis for all types of anisotropic layers.

The present invention also provides a retarder as disclosed hereinabove. In one embodiment of a retarder, the material of the substrate is birefringent and is selected from the list comprising poly ethylene terephtalate (PET), poly ethylene naphtalate (PEN), polyvinyl chloride (PVC), polycarbonate (PC), poly propylene (PP), poly ethylene (PE), polyimide (PI), and poly ester.

In the Table 1 shown below, characteristics of different birefringent materials are presented in comparison with a TAC material:

TABLE 1

| Characteristics | | Material | | | | | | | |
|---|---|---|---|---|---|---|---|---|---|
| | Units | TAC | PET | PEN | PVC | PC | OPP | PE | PI |
| Density | g/cm² | 1.3 | 1.4 | 1.36 | 1.4 | 1.2 | 0.91 | 0.92 | 1.43 |
| Rupture | MPa | 118 | 230 | 280 | 98 | 98 | 186 | 20 | 280 |
| strength | | | | | | | | | |
| Rupture | % | 30 | 120 | 90 | 50 | 140 | 110 | 400 | 280 |
| elongation | | | | | | | | | |
| Water vapor | g/m²/ | 700 | 21 | 6.7 | 35 | 60 | 8 | 20 | 64 |
| transmission | 24 hr | | | | | | | | |
| rate | | | | | | | | | |
| Oxygen | cc/m²/ | 110 | 3 | 1 | 6 | 300 | 100 | 250 | 9.3 |
| transmission | hr/atm | | | | | | | | |
| rate | | | | | | | | | |
| Water | % | 4.4 | 0.4 | 0.3 | 0.05 | 0.2 | 0.01 | 0.02 | 1.3 |
| absorbency | | | | | | | | | |
| Breakdown | kV | 3 | 6.5 | 7.5 | 4 | 6 | 6 | 4 | 7 |
| voltage | | | | | | | | | |
| Volume | Om*cm | 1015 | 1017 | 1017 | 1015 | 1017 | 1016 | 1017 | 1017 |
| resistivity | | | | | | | | | |
| Dielectric | — | 3.5 | 3.2 | 3 | 3 | 3 | 2.1 | 2.3 | 3.3 |
| constant | | | | | | | | | |
| Dielectric | — | 0.02 | 0.002 | 0.003 | 0.01 | 0.002 | 0.003 | 0.0005 | 0.001 |
| tangent | | | | | | | | | |
| Melting point | ° C. | 290 | 258 | 269 | 180 | 240 | 170 | 135 | — |
| Operating | ° C. | to | −70 to | — | −20 to | −100 to | −50 to | −50 to | — |
| temperature | | 120 | 150 | | 80 | 130 | 120 | 75 | |
| Organic solvent | — | bad | good | good | mod- | Mod- | good | good | good |
| tolerance | | | | | erate | erate | | | |
| Acid tolerance | — | bad | good | good | good | good | good | good | good |
| Alkari tolerance | — | bad | mod- | good | good | bad | good | good | bad |
| | | | erate | | | | | | |

As shown in the Table 1, PET material possesses much better mechanical properties, such as rupture strength and rupture elongation, than TAC—thus, substantially thinner film of PET can efficiently replace TAC film. PET is also several times less expensive than TAC. However PET film functions as a positive A-plate exhibiting high birefringence of Δn=0.01-0.05. Other birefringent materials shown in the Table 1, also demonstrate better mechanical properties, and higher environmental resistance which provide their advantage in comparison with a TAC material.

In another embodiment of a retarder, a type of the retardation layer is selected from the list comprising negative A-type and B_{A}-type. In yet another embodiment of a retarder, the retardation layer of the B_{A}-type and negative A-type comprises at least one organic compound of a first type or its salt, and at least one organic compound of a second type. The organic compound of the first type has the general structural formula I

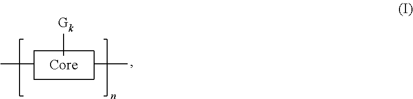

where Core is a conjugated organic unit capable of forming a rigid rod-like macromolecule, n is a number of the conjugated organic units in the rigid rod-like macromolecule which is equal to integers in the range from 10 to 10000, Gₖ is a set of ionogenic side-groups, and k is a number of the side-groups in the set Gₖ, k is a number of the side-groups in the set Gₖ₁ which is equal to 0, 1, 2, 3, 4, 5, 6, 7, or 8. The organic compound of the second type has the general structural formula II

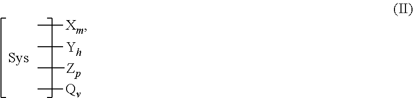

where Sys is an at least partially conjugated substantially planar polycyclic molecular system; X, Y, Z, Q and R are substituents; substituent X is a carboxylic group —COOH, m is 0, 1, 2, 3 or 4; substituent Y is a sulfonic group —SO₃H, h is 0, 1, 2, 3 or 4; substituent Z is a carboxamide —CONH₂, p is 0, 1, 2, 3 or 4; substituent Q is a sulfonamide —SO₂NH₂, v is 0, 1, 2, 3 or 4. The organic compound of the second type forms board-like supramolecules via π-π-interaction, and a composition comprising the compounds of the first and the second types forms lyotropic liquid crystal in a solution with suitable solvent. In still another embodiment of a retarder, the organic compound of the first type is selected from structures 1 to 29 shown in Table 2.

TABLE 2
Examples of the structural formulas of the organic compound of the first type
according to the present invention.

| | |
|---|---|
| 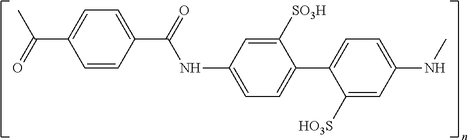 | (1) |
| poly(2,2′-disulfo-4,4′-benzidine terephthalamide) | |
| 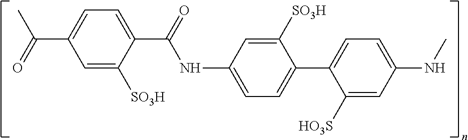 | (2) |
| poly(2,2′-disulfo-4,4′-benzidine sulfoterephthalamide) | |
| 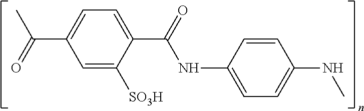 | (3) |
| poly(para-phenylene sulfoterephthalamide) | |
| 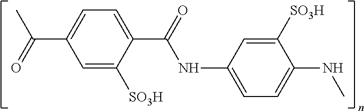 | (4) |
| poly(2-sulfo-1,4-phenylene sulfoterephthalamide) | |
| 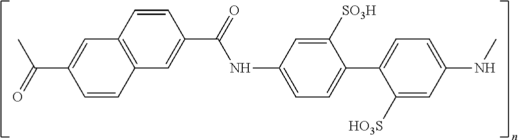 | (5) |
| poly(2,2′-disulfo-4,4′-benzidine naphthalene-2,6-dicarboxamide) | |
| 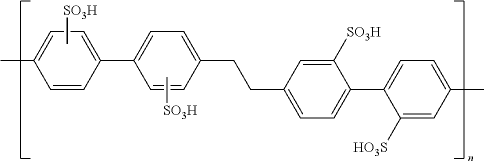 | (6) |
| Poly(tetrasulfo-1,1′:4′,1″:4″,1′′′-quaterphenyl-1,4′′′-ethylen) | |
| 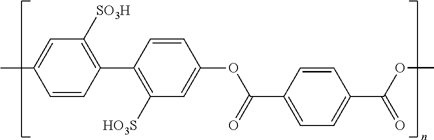 | (7) |
| Poly(2,2′-disulfobiphenyl-dioxyterephthaloyl) | |
| 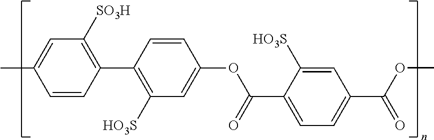 | (8) |
| Poly(2,2′-disulfobiphenyl-2-sulfodioxyterephthaloyl) | |
| 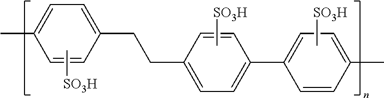 | (9) |
| Poly(trisulfo-1,1′:4′,1″-terphenyl-4,4″-ethylen) | |
| 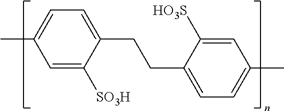 | (10) |
| Poly(2-sulfophenylene-1,2-ethylene-2′-sulfophenylene) | |
| 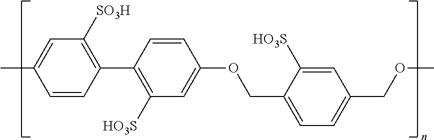 | (11) |
| Poly((1,4-dimethylen-2-sulfobenzene)-(4,4′-dioxi-1,1′- | |
| disulfobiphenyl) ether) | |
| 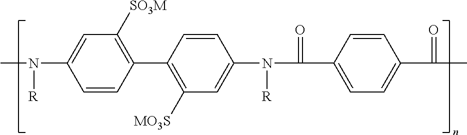 | (12) |
| 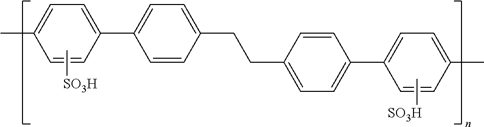 | (13) |
| Poly(disulfo-1,1′: 4′,1″:4″,1′′′-quaterphenyl-4 ,4′′′-ethylen) | |
| 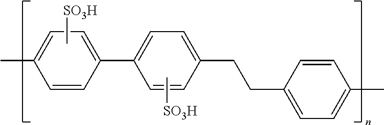 | (14) |
| Poly(disulfo-1,1′:4′,1″-terphenyl-4,4″-ethylen) | |
| 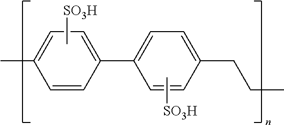 | (15) |
| Poly(disulfobiphenyl-4,4′-ethylen) | |
| 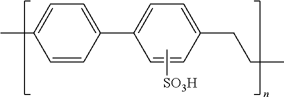 | (16) |
| Poly(sulfobiphenyl-4,4′-ethylen) | |
| 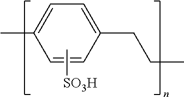 | (17) |
| Poly(sulfo-p-phenylenethylen) | |
| 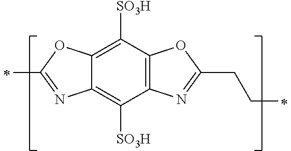 | (18) |
| Poly(4,9-disulfobenzo[1,2-d;5,4-d′]bisoxazole-1,7-ethylene) | |
| 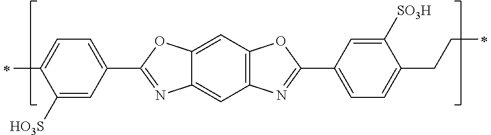 | (19) |
| Poly(benzo[1,2-d;5,4-d′]bisoxazole-1,7-[1,1′-ethane-1,2-diyl-2,2′- | |
| disulfodibenzene]) | |
| 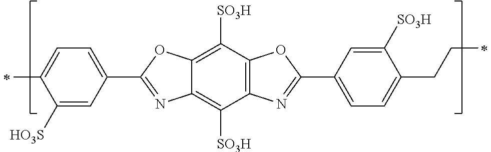 | (20) |
| Poly(4,9-disulfobenzo[1,2-d;5,4-d′]bisoxazole-1,7-[1,1′-ethane-1,2- | |
| diyl-2,2′-disulfodibenzene]) | |
| 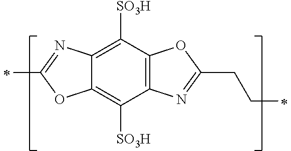 | (21) |
| Poly(4,9-disulfobenzo[1,2-d;4,5-d′]bisoxazole-1,7-ethylene) | |
| 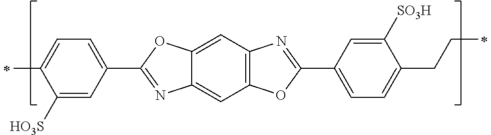 | (22) |
| Poly(benzo[1,2-d;4,5-d′]bisoxazole-1,7-[1,1′-ethane-1,2-diyl-2,2′- | |
| disulfodibenzene]) | |
| 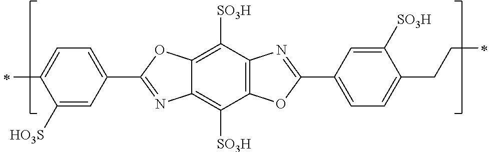 | (23) |
| Poly(4,9-disulfobenzo[1,2-d;4,5-d′]bisoxazole-1,7-[1,1′-ethane-1,2- | |
| diyl-2,2′-disulfodibenzene]) | |
| 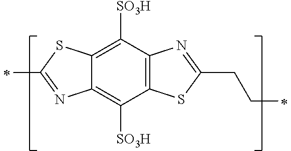 | (24) |
| Poly(4,9-disulfobenzo[1,2-d;4,5-d′]bisthiazole-1,7-ethylene) | |
| 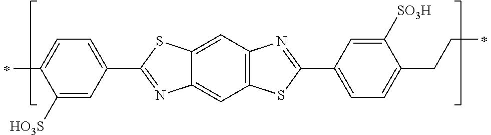 | (25) |
| Poly(benzo[1,2-d;4,5-d′]bisthiazole-1,7-[1,1′-ethane-1,2-diyl-2,2′- | |
| disulfodibenzene]) | |
| 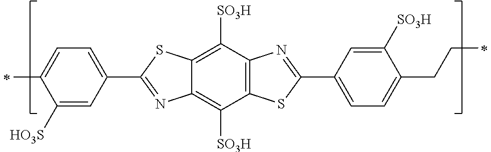 | (26) |
| Poly(4,9-disulfobenzo[1,2-d;4,5-d′]bisthiazole-1,7-[1,1′-ethane-1,2- | |
| diyl-2,2′-disulfodibenzene]) | |
| 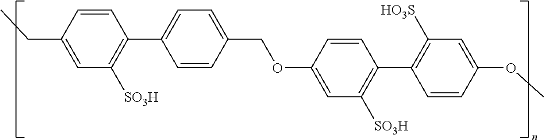 | (27) |
| Poly((4,4′-dimethylen-1-sulfobiphenyl)-(4,4′-dioxi-1,1′- | |
| disulfobiphenyl)ether) | |
| 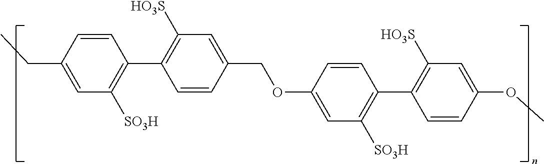 | (28) |
| Poly((4,4′-dimethylen-1,1′-disulfobiphenyl)-(4,4′-dioxi-1,1′- | |
| disulfobiphenyl)ether) | |
| 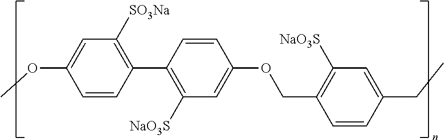 | (29) |
| Poly((1,4-dimethylen-2-sulfophenyl)-(4,4′-dioxi-1,1′-disulfobiphenyl) | |
| ether) | |

where R is a side-group selected from the list comprising Alkil, (CH₂)ₘSO₃H, (CH₂)ₘSi(O Alkyl)₃, CH₂Phenyl, (CH₂)ₘOH and M is counterion selected from the list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, Zr⁴⁺ and NH₄₋ₖQₖ⁺, where Q is selected from the list comprising linear and branched (C1-C20) alkyl, (C2-C20) alkenyl, (C2-C20) alkinyl, and (C6-C20)arylalkyl, and k is 0, 1, 2, 3 or 4.

In one embodiment of a retarder, the organic compound of the first type further comprises additional side-groups independently selected from the list comprising linear and branched (C1-C20)alkyl, (C2-C20)alkenyl, and (C2-C20)alkinyl. In another embodiment of a retarder, at least one of the additional side-groups is connected with the conjugated organic unit Core via a bridging group A selected from the list comprising —C(O)—, —C(O)O—, —C(O)—NH—, —(SO₂)NH—, —O—, —CH₂O—, —NH—, >N—, and any combination thereof. In yet another embodiment of a retarder, the salt of the organic compound of the first type is selected from the list comprising ammonium and alkali-metal salts. In still another embodiment of a retarder, the organic compound of the second type has at least partially conjugated substantially planar polycyclic molecular system Sys selected from the structures with general formula 30 to 44 shown in Table 3.

TABLE 3
Examples of the structural formulas of the organic compound of the second
type according to the present invention.

| | |
|---|---|
| 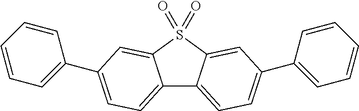 | (30) |
| 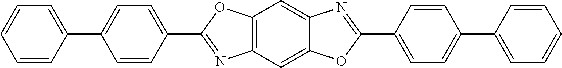 | (31) |
| 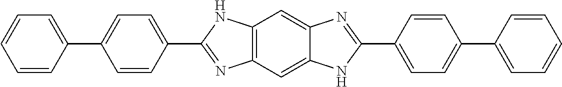 | (32) |
| 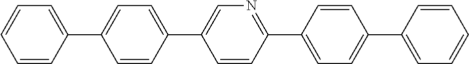 | (33) |
| 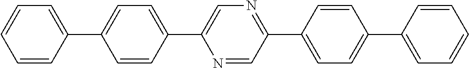 | (34) |
| 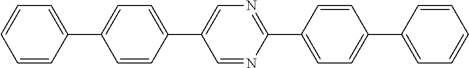 | (35) |
| 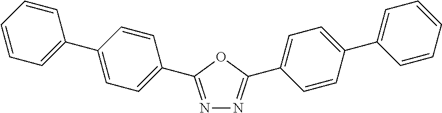 | (36) |
| 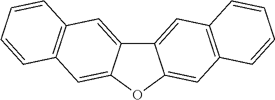 | (37) |
| 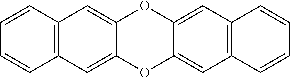 | (38) |
| 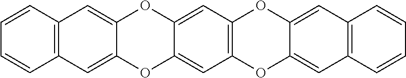 | (39) |
| 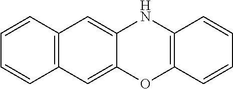 | (40) |
| 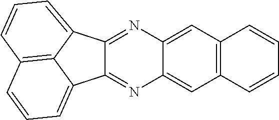 | (41) |
| 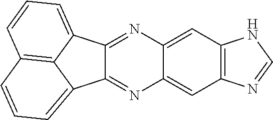 | (42) |
| 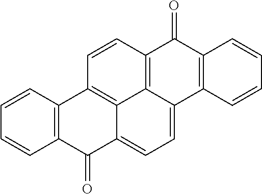 | (43) |
| 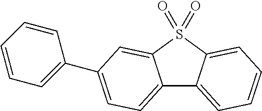 | (44) |

In one embodiment of a retarder, the organic compound of the second type is selected from structures 45 to 53 shown in Table 4, where the molecular system Sys is selected from the structures 30 and 37 to 44, the substituent is a sulfonic group —SO₃H, and m1, p1, and v1, are equal to 0.

TABLE 4
Examples of the structural formulas of the organic compound of the second
typewith is a sulfonic group —SO₃H as substituent according to the present invention.

| | |
|---|---|
| 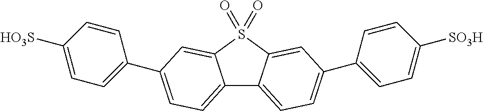 | (45) |
| 4,4′-(5,5-dioxidodibenzo[b,d]thiene-3,7-diyl)dibenzenesulfonic | |
| acid | |
| 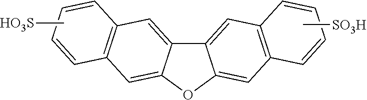 | (46) |
| dinaphto[2,3-b:2′,3′-d]furan disulfonic acid | |
| 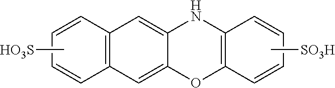 | (47) |
| 12H-benzo[b]phenoxazine disulfonic acid | |
| 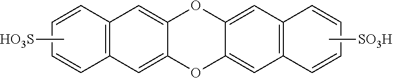 | (48) |
| dibenzo[b,i]oxanthrene disulfonic acid | |
| 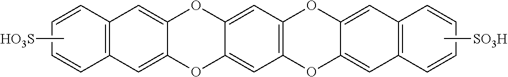 | (49) |
| benzo[b]naphto[2′,3′:5,6]dioxino[2,3-i]oxanthrene disulfonic acid | |
| 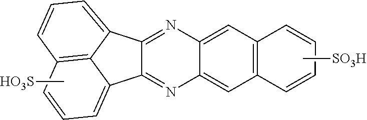 | (50) |
| acenaphtho[1,2-b]benzo[g]quinoxaline disulfonic acid | |
| 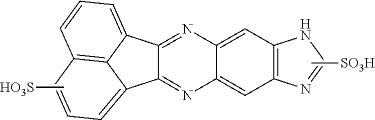 | (51) |
| 9H-acenaphtho[1,2-b]imidazo [4,5-g]quinoxaline disulfonic acid | |
| 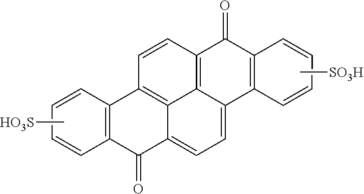 | (52) |
| dibenzo[b,def]chrysene -7,14-dion disulfonic acid | |
| 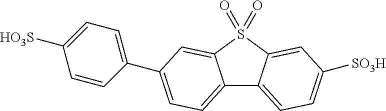 | (53) |
| 7-(4-sulfophenyl)dibenzo[b,d]thiophene-3-sulfonic acid 5,5- | |
| dioxide | |

In another embodiment of a retarder, the organic compound of the second type further comprises at least one substituent selected from the list comprising CH₃, C₂H₅, Cl, Br, NO₂, F, CF₃, CN, OH, OCH₃, OC₂H₅, OCOCH₃, OCN, SCN, and NHCOCH₃.

In one embodiment of a retarder, the substrate comprises a non-birefringent layer and a positive A-type retardation layer. In another embodiment of a retarder, a material of the non-birefringent layer is selected from the list comprising triacetyl cellulose (TAC), cyclic olefin polymer (COP), Acrylic, and Z-TAC. In still another embodiment of a retarder, the positive A-type retardation layer comprises the organic compound which is selected from structures shown in Table 2.

The present invention also provides a liquid crystal display as disclosed hereinabove. In one embodiment of a liquid crystal display, the liquid crystal cell is an in-plane switching mode liquid crystal cell. In another embodiment of a liquid crystal display, the liquid crystal cell is a vertically-aligned mode liquid crystal cell. In yet another embodiment of a liquid crystal display, the retarder is located inside the liquid crystal cell. In still another embodiment of a liquid crystal display, wherein the retarder is located outside the liquid crystal cell. In one embodiment of a liquid crystal display, the material of the substrate is birefringent and is selected from the list comprising poly ethylene terephtalate (PET), poly ethylene naphtalate (PEN), polyvinyl chloride (PVC), polycarbonate (PC), poly propylene (PP), poly ethylene (PE), polyimide (PI), and poly ester. In another embodiment of a liquid crystal display, a type of the retardation layer is selected from the list comprising negative A-type and B_{A}-type. In still another embodiment of a liquid crystal display, the retardation layer of the B_{A}-type and negative A-type comprise at least one organic compound of a first type or its salt, and at least one organic compound of a second type. The organic compound of the first type has the general structural formula I

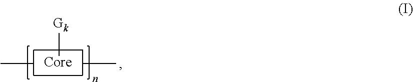

where Core is a conjugated organic unit capable of forming a rigid rod-like macromolecule, n is a number of the conjugated organic units in the rigid rod-like macromolecule which is equal to integers in the range from 10 to 10000, Gₖ is a set of ionogenic side-groups, and k is a number of the side-groups in the set Gₖ, k is a number of the side-groups in the set Gₖ₁ which is equal to 0, 1, 2, 3, 4, 5, 6, 7, or 8.

The organic compound of the second type has the general structural formula II

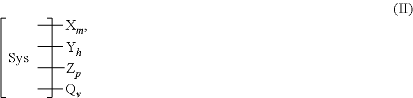

where Sys is at least partially conjugated substantially planar polycyclic molecular system; X, Y, Z, Q and R are substituents; substituent X is a carboxylic group —COOH, m is 0, 1, 2, 3 or 4; substituent Y is a sulfonic group —SO₃H, h is 0, 1, 2, 3 or 4; substituent Z is a carboxamide —CONH₂, p is 0, 1, 2, 3 or 4; substituent Q is a sulfonamide —SO₂NH₂, v is 0, 1, 2, 3 or 4; wherein the organic compound of the second type forms board-like supramolecules via π-π-interaction, and a composition comprising the compounds of the first and the second types forms lyotropic liquid crystal in a solution with suitable solvent. In yet another embodiment of a liquid crystal display, the organic compound of the first type is selected from the structures 1 to 29 shown in Table 2. In one embodiment of a liquid crystal display, the organic compound of the first type further comprises additional side-groups independently selected from the list comprising linear and branched (C₁-C₂₀)alkyl, (C₂-C₂₀)alkenyl, and (C₂-C₂₀)alkinyl In another embodiment of a liquid crystal display, at least one of the additional side-groups is connected with the conjugated organic unit Core via a bridging group A selected from the list comprising —C(O)—, —C(O)O—, —C(O)—NH—, —(SO₂)NH—, —O—, —CH₂O—, —NH—, >N—, and any combination thereof. In still another embodiment of a liquid crystal display, salt of the organic compound of the first type is selected from the list comprising ammonium and alkali-metal salts. In yet another embodiment of a liquid crystal display, the organic compound of the second type has at least partially conjugated substantially planar polycyclic molecular system Sys selected from the structures of the general formulas 30 to 44 shown in Table 3. In one embodiment of a liquid crystal display, the organic compound of the second type is selected from the structures 45 to 53 shown in Table 4, where the molecular system Sys is selected from the structures 30 and 37 to 44, the substituent is a sulfonic group —SO₃H, and m1, p1, and v1 are equal to 0. In another embodiment of a liquid crystal display, the organic compound of the second type further comprises at least one substituent selected from the list comprising CH₃, C₂H₅, Cl, Br, NO₂, F, CF₃, CN, OH, OCH₃, OC₂H₅, OCOCH₃, OCN, SCN, and NHCOCH₃.

In still another embodiment of a liquid crystal display, the substrate comprises a non-birefringent layer and a positive A-type retardation layer. In yet another embodiment of a liquid crystal display, a material of the non-birefringent layer is selected from the list comprising triacetyl cellulose (TAC), cyclic olefin polymer (COP), Acrylic, and Z-TAC. In one embodiment of a liquid crystal display, the positive A-type retardation layer comprises the organic compound which is selected from structures 1-29 shown in Table 2:

In order that the invention may be more readily understood, reference is made to the following examples, which are intended to be illustrative of the invention, but are not intended to be limiting in scope.

### Example 1

This Example describes synthesis of poly(2,2′-disulfo-4,4′-benzidine sulfoterephthalamide) which is an example of the organic compound of the structural formula 2 shown in Table 2 with SO₃H group that serves as ionogenic side-groups Gₖ:

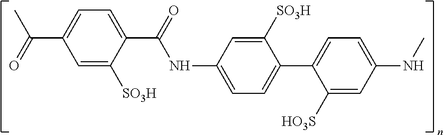

10 g (40 mmol) of 2-sulfoterephtalic acid, 27.5 g (88.7 mmol) of triphenylphosphine, 20 g of lithium chloride and 50 ml of pyridine were dissolved in 200 ml of N-methylpyrrolidone in a 500 ml three-necked flask. The mixture was stirred at 40° C. for 15 min and then 13.77 g (40 mmol) of 4,4′-diaminobiphenyl-2,2′-disulfonic acid were added. The reaction mixture was stirred at 115° C. for 3 hours. 1 L of methanol was added to the viscous solution, a formed yellow precipitate was filtrated and washed sequentially with methanol (500 ml) and diethyl ether (500 ml). Yellowish solid was dried in vacuo at 80° C. overnight.

### Example 2

The Example describes synthesis of 4,4′-(5,5-dioxidodibenzo[b,d]thiene-3,7-diyl)dibenzenesulfonic acid which is an example of the organic compound of the structural formula 45 shown in Table 4.

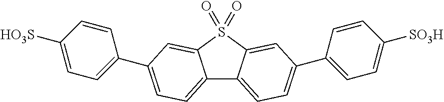

1,1′:4′,1″:4″,1′″-quarerphenyl (10 g) was charged into 0%-20% oleum (100 ml). Reaction mass was agitated for 5 hours at heating to 50° C. After that the reaction mixture was diluted with water (170 ml). The final sulfuric acid concentration was approximately 55%. The precipitate was filtered and rinsed with glacial acetic acid (˜200 ml). The filter cake was dried in an oven at 110° C.

HPLC analysis of the sample was performed with Hewlett Packard 1050 chromatograph with a diode array detector (λ=310 nm), using Reprosil™ Gold C8 column and linear gradient elution with acetonitrile/0.4 M ammonium acetate (pH=3.5 acetic acid) aqueous solution.

### Example 3

This Example describes preparation of a retardation layer of the B_{A}-type from a solution comprising a binary composition of poly(2,2′-disulfo-4,4′-benzidine sulfoterephthalamide) described in Example 1 and denoted below as P2 and 4,4′-(5,5-dioxidodibenzo[b,d]thiene-3,7-diyl)dibenzenesulfonic acid described in Example 2 and denoted below as C1.

The P2/C1=35/65 molar % composition was prepared as follows. 2.86 g (0.0035 mol) of the cesium salt of P2 was dissolved in 70 g of de-ionized water (conductivity ˜5 μSm/cm), and the suspension was mixed with a magnet stirrer. After dissolving, the solution was filtered at the hydrophilic nylon filter with pore size 45 μm. Separately, 3.44 g (0.0065 mol) of C1 was dissolved in 103 g of de-ionized water, and suspension was mixed with a magnet stirrer. While stirring, 7.75 ml of 20 wt. % cesium hydroxide was gradually added drop-by-drop into the suspension for approximately 15 minutes until a clear solution was formed. Clear solutions of P2 and C1 were mixed together to form 400 g of a clear solution. This composition was concentrated on a rotary evaporator in order to remove an excess of water and form 70 g of a binary composition representing a lyotropic liquid crystal (LLC) solution. The total concentration of composition (P2+C1) C_{TOT} was equal to about 11%. The coatings were produced and optically characterized. Gardner® wired stainless steel rod #4 was used instead of Gardner® wired stainless steel rod #8. The obtained solid optical retardation layer was characterized by principle refractive indices, which obey the following condition: nₓ<n_{z}<n_{y}. The NZ-factor at wavelength λ=550 nm is equal to about 0.7.

### Example 4

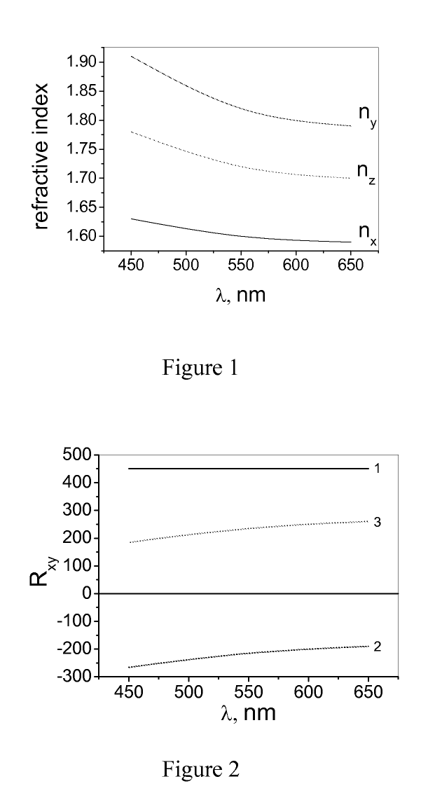

This Example describes preparation of a retarder according to the present invention. Structure of the retarder comprising the retardation layer prepared according to Example 3 and a substrate made of poly propylene (PP) birefringent material. The PP substrate exhibits a birefringence of Δn˜0.01 and properties of positive A-plate with the optical axis lying in the substrate plane. The retardation layer is a biaxial BA-type retarder characterized by principal refractive indices as shown in FIG. 1, where the x-axis coincides with the coating direction corresponding to the lowest refractive index. In this Example the coating direction coincides with the direction of the largest PP-substrate refractive index. In this case positive birefringence of the PP-substrate is competing with the negative optical anisotropy of the retardation layer. Thus, the resulting retardation of the retarder (curve 3 in FIG. 2) versus wavelength λ is the sum of those provided by PP-substrate (curve 1) and retardation layer (curve 2):

R_{xy}(λ)=(n_{x,TBF}(λ)−n_{y,TBF}(λ))d_{TBF}+

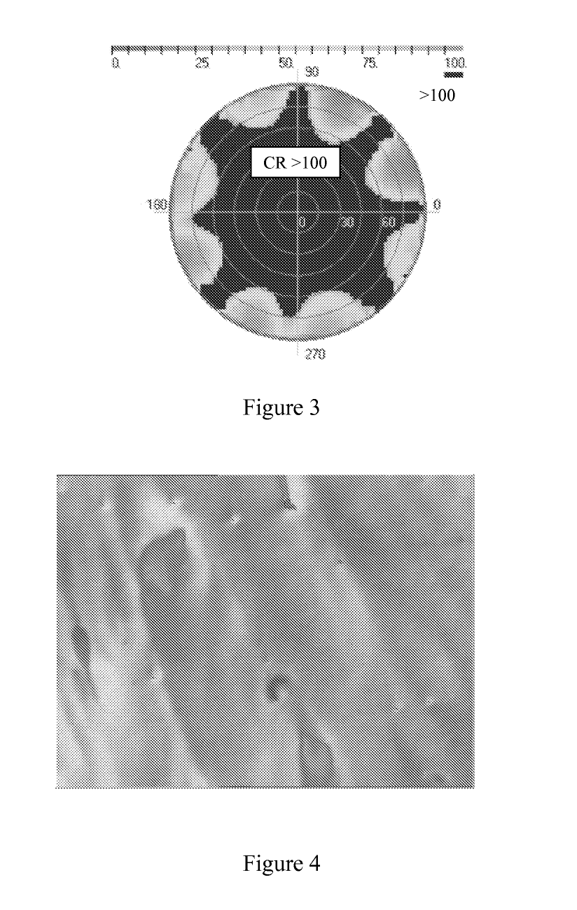

(n_{x,OPP}(λ)−n_{y,OPP}(λ))d_{OPP},

where nₓ, n_{y} and d are the principal values of the in-plane refractive indices and thickness for retardation layer and PP-substrate, and R_{xy} is the resultant in-plane retardation. Thickness of the retardation layer and the PP-substrate is 0.95 μm and 45 μm, respectively. It is important to note that the resulting in-plane retardation is characterized by anomalous spectral dispersion (|dR/dλ|>0) due to much stronger normal spectral dispersion of refractive indices of the retardation layer as compared with that of the PP-substrate (FIG. 3). The anomalous dispersion of retardation has a considerable impact on efficiency of the optical compensation of LCD because the phase retardation of the light propagating in z-direction is presented by the known relationship:

$${ΔΦ}_{z} ( λ ) = \frac{2 π}{λ} {R}_{xy} ( λ ) .$$

The anomalous spectral dispersion means that the absolute value of the in-plane retardation R_{xy} grows as the wavelength increases. The latter results in decreasing the phase retardation change over the wavelength. For instance, if the retardation is proportional to the wavelength (R_{xy}(λ)˜λ), then the phase delay ΔΦ_{z} becomes a spectrally independent value, and optical compensation is provided in a wide spectral range.

### Example 5

This Example describes one preferred embodiment of the IPS mode liquid crystal display according to the present invention. It is shown that the anomalous type of dispersion provided by retardation of the Ba type on the PP-substrate results in further improvement of the spectral performance. The IPS LCD comprises the optical layers as follows,
rear polarizer with the transmission axis at an azimuth φ=−45°,
protective TAC film with negative C-type retardation of 40 nm,
IPS LC cell with a retardation of 275 nm aligned at an azimuth of 45°,
BA-type retardation layer of 950 nm in thickness with the coating direction at an azimuth of 45°,
PP-substrate with +A-type retardation of 450 nm and optical axis at an azimuth of +45°, and
front polarizer with the transmission axis at an angle of +45°.
   FIG. 3 shows the viewing angle performance at a wavelength of 550 nm. It corresponds to high performance with contrast ratio exceeding 100 for the total viewing angle sector in horizontal and vertical directions. The azimuth angle φ=+45° and φ=−45° can be related to the horizontal and vertical directions respectively.

### Example 6

This Example describes synthesis of 7-(4-sulfophenyl)dibenzo[b,d]thiophene-3-sulfonic acid 5,5-dioxide (structure 53 in Table 4).

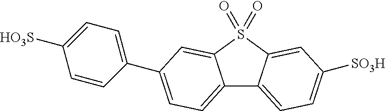

7.83 g of p-terphenyl was dissolved in 55 ml of 10% oleum at 10-20° C., and the mixture was stirred for 20 hrs at an ambient temperature. 20 g of ice was added to the formed suspension, and the mixture was cooled to 0° C. The solid was filtered and washed with 36% hydrochloric acid, dissolved in min amount of water (the solution was filtered from impurities) and precipitated with 36% hydrochloric acid. The product was filtered, washed with 36% hydrochloric acid and dried. 9.23 g was obtained.

### Example 7

This example describes preparation of solution comprising a triple composition of cesium salts of poly(2,2′-disulfonyl-4,4′-benzidine terephthalamide) also known as PBDT in literature, 4,4′-(5,5-dioxidodibenzo[b,d]thiene-3,7-diyl)dibenzenesulfonic acid (structure 45) and 7-(4-sulfophenyl)dibenzo[b,d]thiophene-3-sulfonic acid 5,5-dioxide (structure 53). Said composition of organic compounds is capable to form a joint lyotropic liquid crystal system. The rigid rod-like macromolecules of PBDT are capable to align together with π-π stacks (columns) of rod-like supramolecules of the compound of the structures 45 and 53.

PBDT/(compound 45)/(compound 53)=19.7/78.6/1.7 mass % composition was prepared as follows:
(i) Preparation of PBDT raw solution. 2.0 mass % of PBDT solid materials was added to 98.0 mass % of de-ionized water (conductivity ˜5 μSm/cm). The suspension was stirred at 500 rpm at 75° C. until full dissolving. Then 2% solution was filtered with a Millipore filter of 0.3 μm PHWP covered with a glass fiber pre-filter. After that the solution was evaporated to higher concentration (25%). At this concentration solution is in LLC state.
(ii) Preparation of the raw solution of the compound 45. 10.7 mass % of the acid form of the compound 43 (containing 10.52% of water) was suspended with warm 70.9 mass % of de-ionized water (conductivity ˜5 μSm/cm). Then 0.5 mass % of glacial acetic acid was added and followed by addition of 17.9 mass % of water solution of cesium hydroxide monohydrate (solution concentration 42.3%). The mixture was heated up to 90° C. while stirring. After that approximately 10% (of total mass of solution) of silcarbon was added to the mixture continuing stirring at 90-95° C. for 90 min. Hot suspension was filtered on Buchner funnel through two glass fiber filters (D=185 mm). Obtained filtrate was filtered again on Buchner funnel through a membrane (0.3 mkm, D=35 mm) and was allowed to cool to room temperature. The final solution is in a lyotropic liquid state having pH of 6.0-7.0 and concentration of 16.0%.
(iii) Final triple mixture for BA-type plate ((compound 45)+PBDT+(compound 53)) preparation. 1000 g of 16% raw solution of the compound 45 was mixed with 160 g of 25% PBDT raw solution with addition of 3.5 g of compound 53 solid material and 19 g of acetic acid in 108 g of de-ionized water. Mixing was performed by Ultra-turrax IKA T25 dispergator at 10,000 rpm for 40 min. Final triple composition is a lyotropic liquid crystal solution. The polarized microscopy image of LLC triple solution is presented in FIG. 4 (magnification 100×).

### Example 8

This Example describes synthesis of poly(2,2′-disulfo-4,4′-benzidine sulfoterephthalamide) (structure 2 in Table 2).

10 g (40 mmol) of 2-sulfoterephtalic acid, 27.5 g (88.7 mmol) of triphenylphosphine, 20 g of Lithium chloride and 50 ml of pyridine were dissolved in 200 ml of N-methylpyrrolidone in a 500 ml three-necked flask. The mixture was stirred at 40° C. for 15 min and then 13.77 g (40 mmol) of 4,4′-diaminobiphenyl-2,2′-disulfonic acid were added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 9

This Example describes synthesis of poly(para-phenylene sulfoterephthalamide) (structure 3 in Table 2).

10 g (40 mmol) of 2-sulfoterephtalic acid, 27.5 g (88.7 mmol) of triphenylphosphine, 20 g of Lithium chloride and 50 ml of pyridine were dissolved in 200 ml of N-methylpyrrolidone in a 500 ml three-necked flask. The mixture was stirred at 40° C. for 15 min and then 4.35 g (40 mmol) of 1,4-phenylenediamine were added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 10

This Example describes synthesis of poly(2-sulfo-1,4-phenylene sulfoterephthalamide) (structure 4 in Table 2).

10 g (40 mmol) of 2-sulfoterephtalic acid, 27.5 g (88.7 mmol) of triphenylphosphine, 20 g of lithium chloride and 50 ml of pyridine were dissolved in 200 ml of N-methylpyrrolidone in a 500 ml three-necked flask. The mixture was stirred at 40° C. for 15 min and then 7.52 g (40 mmol) of 2-sulfo-1,4-phenylenediamine were added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 11

This Example describes synthesis of poly(2,2′-disulfo-4,4′-benzidine naphthalene-2,6-dicarboxamide) cesium salt (structure 5 in Table 2).

0.344 g (0.001 mol) of 4,4′-diaminobiphenyl-2,2′-disulfonic acid was mixed with 0.3 g (0.002 mol) of cesium hydroxide and 10 ml of water and stirred with dispersing stirrer till dissolution. 0.168 g (0.002 mol) of sodium bicarbonate was added to the solution and stirred. While stirring the obtained solution at high speed (2500 rpm) the solution of 0.203 g (0.001 mol) of terephthaloyl dichloride in dried toluene (4 mL) was gradually added within 5 minutes. The stirring was continued for 5 more minutes, and viscous white emulsion was formed. Then the emulsion was diluted with 10 ml of water, and the stirring speed was reduced to 100 rpm. After the reaction mass has been homogenized the polymer was precipitated via adding 60 ml of acetone. The fibrous sediment was filtered and dried. Molecular weight analysis of the sample via GPC was performed as described in Example 1.

### Example 12

This example describes synthesis of Poly(disulfobiphenylene-1,2-ethylene-2,2′-disulfobiphenylene) (structure 6 in Table 2).

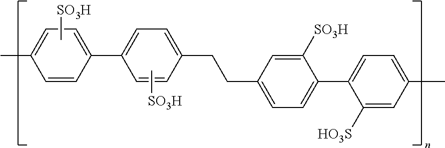

36 g of finely ground bibenzyl in a petri dish is set on a porcelain rack in a dessicator with an evaporating dish under the rack containing 80 g of bromine. The dessicator is closed but a very small opening is provided for the escape of hydrogen bromide. The bibenzyl is left in contact with the bromine vapors for overnight. Then the dish with Bromine is removed from the dessicator and the excess of bromine vapors evacuated by water pump. The orange solid is then recrystallized from 450 ml of Isopropyl alcohol. The yield of 4,4′-dibromobibenzyl is 20 g.

To a stirred solution of 3 g of 4,4′-dibromobibenzyl in 100 ml of dry tetrahydrofuran under argon, a 5.4 ml of 2.5 M solution of butyllithium in hexane is added dropwise at −78° C. The mixture is stirred at this temperature 6 hrs to give a white suspension. 6 ml of triisopropylborate is added and the mixture is stirred overnight allowing the temperature to rise to room temperature. 30 ml of water is added and the mixture stirred at room temperature 4 hrs. The organic solvents are removed on a rotavapor (35° C., 40 mbar), then 110 ml of water is added and the mixture acidified with concentrated HCl. The product is extracted into diethyl ether (7×30 ml), the organic layer dried over magnesium sulfate and the solvent removed on a rotavapor. The residue is dissolved in 11 ml of acetone and reprecipitated into a mixture of 13 ml of water and 7 ml of concentrated hydrochloric acid. The yield of dipropyleneglycol ester of bibenzyl 4,4′-diboronic Acid is 2.4 g.

100 g of 4,4′-diamino-2,2′-biphenyldisulfonic acid, 23.2 g of sodium hydroxide and 3500 ml of water are mixed and cooled to 0-5° C. A solution of 41 g of sodium nitrite in 300 ml of water is added, the solution is stirred for 5 min and then 100 ml of 6M hydrochloric acid is added. A pre-cooled solution of 71.4 g of potassium bromide in 300 ml of water is added to the resulting dark yellow solution in 2 ml portions. After all the potassium bromide has been added the solution is allowed to warm up to room temperate. Then the reaction mixture is heated and held at 90° C. for 16 hours. A solution of 70 g of sodium hydroxide in 300 ml of water is added, the solution evaporated to a total volume of 400 ml, diluted with 2500 ml of methanol to precipitate the inorganic salts and filtered. The methanol is evaporated to 20-30 ml and 3000 ml of isopropanol is added. The precipitate is washed with methanol on the filter and recrystallized from methanol. Yield of 4,4′-dibromo-2,2′-biphenyldisulfonic acid is 10.7 g.

The polymerization is carried out under nitrogen. 2.7 g of 4,4′-dihydroxy-2,2′-biphenyldisulfonic acid and 2.0 g of dipropyleneglycol ester of bibenzyl 4,4′-diboronic Acid are dissolved in a mixture of 2.8 g of sodium hydrocarbonate, 28.5 ml of tetrahydrofuran and 17 ml of water. Tetrakis(triphenylphosphine)palladium(0) is added (5×10⁻³ molar equivalent compared to dipropyleneglycol ester of bibenzyl 4,4′-diboronic acid). The resulting suspension is stirred 20 hrs. 0.04 g of dromobenzene is then added. After an additional 2 hrs the polymer is precipitated by pouring it into 150 ml of ethanol. The product is washed with water, dried, and dissolved in toluene. The filtered solution is concentrated and the polymer precipitated in a 5-fold excess of ethanol and dried. The yield of polymer is 2.7 g.

8.8 g of 95% sulfuric acid is heated to 110° C. and 2.7 g of the polymer is added. The temperature is raised to 140° C. and held for 4 hours. After cooling down to 100° C. 8 ml of water is added dropwise and the mixture is allowed to cool. The resulting suspension is filtered, washed with conc. Hydrochloric acid and dried. Yield of the sulfonated polymer is ˜2 g.

### Example 13

This example describes synthesis of Poly(2,2′-disulfobiphenyl-dioxyterephthaloyl) (structure 7 in Table 2).

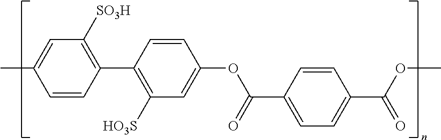

1.384 g (0.004 mol) of 4,4′-dihydroxybiphenyl-2,2′-disulfonic acid was mixed with 2.61 g (0.008 mol) of sodium carbonate and 40 ml of water in 500 ml beaker and stirred with dispersing stirrer until the solid completely dissolved. Dichloromethane (50 ml) was added to the solution. Upon stirring at high speed (7000 rpm) the solution of 0.812 g (0.004 mol) of terephthaloyl chloride in anhydrous dichloromethane (15 ml) was added. Stirring was continued for 30 minutes and 400 ml of acetone were added to the thickened reaction mass. Solid polymer was crushed with the stirrer and separated by filtration. The product was washed three times with 80% ethanol and dried at 50° C.

### Example 14

This example describes synthesis of Poly(2,2′-disulfobiphenyl-2-sulfodioxyterephthaloyl) (structure 8 in Table 2).

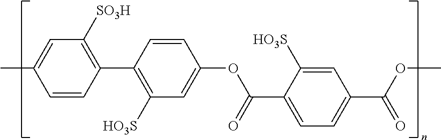

1.384 g (0.004 mol) of 4,4′-dihydroxybiphenyl-2,2′-disulfonic acid was mixed with 3.26 g (0.010 mol) of sodium carbonate and 40 ml of water in 500 ml beaker and stirred with dispersing stirrer until the solid completely dissolved. Dichloromethane (60 ml) was added to the solution. Upon stirring at high speed (7000 rpm) 1.132 g (0.004 mol) of 2-sulfoterephthaloyl chloride was added within 15 minutes. Stirring was continued for 3 hours and 400 ml of acetone were added to the thickened reaction mass. Precipitated polymer was separated by filtration and dried at 50° C.

### Example 15

This example describes synthesis of Poly(sulfophenylene-1,2-ethylene-2,2′-disulfobiphenylene) (structure 9 in Table 2).

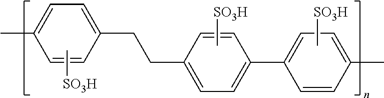

36 g of finely ground bibenzyl in a petri dish is set on a porcelain rack in a dessicator with an evaporating dish under the rack containing 80 g of bromine. The dessicator is closed but a very small opening is provided for the escape of hydrogen bromide. The bibenzyl is left in contact with the bromine vapors for overnight. Then the dish with bromine is removed from the dessicator and the excess of bromine vapors evacuated by water pump. The orange solid is then recrystallized from 450 ml of Isopropyl alcohol. The yield of 4,4′-dibromobibenzyl is 20 g.

A solution of 23.6 g of 1,4-dibromobenzene in 90 ml of dry tetrahydrofuran is prepared. 10 ml of the solution is added with stirring to 5.0 g of Magnesium chips and iodine (a few crystals) in 60 ml of dry tetrahydrofuran and the mixture heated until reaction starts. Boiling conditions are maintained by the gradual addition of the rest of dibromobenzene solution. Then the reaction mixture is boiled for 8 hours and left overnight under argon at room temperature. The mixture is transferred through a hose to a dropping funnel by means of argon pressure and added to a solution of 24 ml of trimethylborate in 40 ml of dry tetrahydrofuran during 3 h at −78-70° C. (solid carbon dioxide/acetone bath) and vigorous stirring. The mixture is stirred for 2 hrs, then allowed to heat to room temperature with stirring overnight under argon. The mixture is diluted with 20 ml of ether and poured to a stirred mixture of crushed ice (200 g) and conc. H₂SO₄ (6 ml). To facilitate separation of the organic and aqueous layers 20 ml of ether and 125 ml of water are added and the mixture is filtered. The aqueous layer is extracted with ether (4×40 ml), the combined organic extracts are washed with 50 ml of water, dried over Sodium sulfate and evaporated to dryness. The light brown solid is dissolved in 800 ml of chloroform and clarified.

The chloroform solution is evaporated almost to dryness and the residual solid is recrystallized from benzene. A white slightly yellowish precipitate is filtered off and dried. The yield of dipropyleneglycol ester of benzyne 1,4-diboronic acid is 0.74 g.

The polymerization is carried out under nitrogen. 2.7 g of 4,4′-dibromo-2,2′-bibenzyl and 1.9 g of dipropyleneglycol ester of benzyne 1,4-diboronic acid are added to in a mixture of 2.8 g of sodium hydrocarbonate, 28.5 ml of tetrahydrofuran and 17 ml of water. Tetrakis(triphenylphosphine)palladium(0) is added (5×10⁻³ molar equivalent compared to dipropyleneglycol ester of benzyne 1,4-diboronic acid). The resulting suspension is stirred 20 hrs. 0.04 g of bromobenzene is then added. After an additional 2 hrs the polymer is precipitated by pouring it into 150 ml of ethanol. The product is washed with water, dried, and dissolved in toluene. The filtered solution is concentrated and the polymer precipitated in a 5-fold excess of ethanol and dried. The yield of polymer is 2.5 g.

8.8 g of 95% sulfuric acid is heated to 110° C. and 2.7 g of the polymer is added. The temperature is raised to 140° C. and held for 4 hours. After cooling down to the room temperature 8 ml of water is added dropwise and the mixture is allowed to cool. The resulting suspension is filtered, washed with conc. Hydrochloric acid and dried. Yield of the sulfonated polymer is 1.5 g.

### Example 16

This example describes synthesis of Poly(2-sulfophenylene-1,2-ethylene-2′-sulfophenylene) (structure 10 in Table 2).

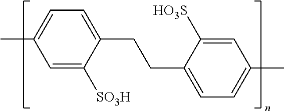

The polymerization is carried out under nitrogen. 10.2 g of 2,2′-[ethane-1,2-diylbis(4,1-phenylene)]bis-1,3,2-dioxaborinane, 10.5 g of 1,1′-ethane-1,2-diylbis(4-bromobenzene) and 1 g of tetrakis(triphenylphosphine)palladium(0) are mixed under nitrogen. Mixture of 50 ml of 2.4 M solution of potassium carbonate and 300 ml of tetrahydrofuran is degassed by nitrogen bubbling. Obtained solution is added to the first mixture. After that reaction mixture is agitated at ˜40° C. for 72 hours. The polymer is precipitated by pouring it into 150 ml of ethanol. The product is washed with water and dried. The yield of polymer is 8.7 g.

8.5 g of polymer is charged into 45 ml of 95% sulfuric acid. Reaction mass is agitated at ˜140° C. for 4 hours. After cooling down to the room temperature 74 ml of water are added dropwise and the mixture is allowed to cool. The resulting suspension is filtered, washed with conc. Hydrochloric acid and dried. Yield of the sulfonated polymer is 8 g.

### Example 17

This example describes synthesis of Poly(2,2′-disulfobiphenyl-2-sulfo-1,4-dioxymethylphenylene) (structure 11 in Table 2).

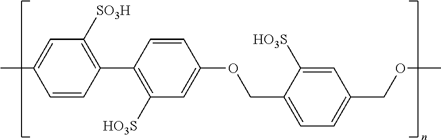

190 g of 4,4′-diaminobiphenyl-2,2′-disulfonic acid and 41.5 g of Sodium hydroxide are dissolved in 1300 ml of water. 1180 g of ice is charged to this solution with stirring. Then 70.3 g of Sodium nitrite, 230.0 ml of Sulfuric acid and 1180 ml of water is added to the reaction mass and it is stirred for 1 hr at −2-0° C. Then it is filtered and washed with 2400 ml of icy water. The filter cake is suspended in 800 ml of water and heated to 100° C. Then the water is distilled out until about ˜600 ml of solution remained. 166 g of Cesium hydroxide hydrate in 110 ml of water is added to the solution. Then it is added to 6000 ml of ethanol, the resulting suspension is stirred at room temperature, filtered and the filter cake washed with 600 ml of ethanol and dried in vacuum oven at 45° C. The yield of 4,4′-dihydroxybiphenyl-2,2′-disulfonic acid is 230 g.

30 ml of 96% sulfuric acid and 21 g of p-xylene are mixed, heated to 100° C. and kept at temperature for 15 min. The reaction mass is cooled to room temperature, quenched with 50 g water and ice. The resulting suspension is cooled to −10° C., filtered and the obtained filter cake washed with cold hydrochloric acid (15 ml of conc. acid and 10 ml of water). The precipitate is squeezed and recrystallized from hydrochloric acid solution (40 ml of conc. acid and 25 ml of water). The white substance is dried under vacuum at 90° C. The yield of p-xylene sulfonic acidis 34 g.

A mixture of 35 ml of Carbon Tetrachloride, 2.5 g of p-xylene sulfonic acid, 4.8 g of n-bromosuccinimide and 0.16 g of benzoyl peroxide is heated with agitation to boiling and held at temperature 60 min. Then additional 0.16 g of benzoyl peroxide is added and the mixture kept boiling for additional 60 min. After cooling the product is extracted with 45 ml of water and recrystallized form 20% hydrochloric acid. The yield of 2,5-bis(bromomethyl)benzene sulfonic acid is approximately 1 g.

To a 25-ml flask equipped with a condenser and nitrogen inlet-outlet are successively added 0.23 g of 4,4′-dihydroxybiphenyl-2,2′-disulfonic acid, 1.2 ml of o-dichlorobenzene, 0.22 g of 2,5-bis(bromomethyl)benzene sulfonic Acid, 1.2 ml of 10N sodium hydroxide, and 0.081 g of tetrabutylammonium hydrogen sulfate. The reaction mixture is stirred at 80° C. under nitrogen. After 6 hrs of reaction the organic layer is isolated and washed with water, followed by dilute hydrochloric acid, and again with water. Then the solution is added to methanol to precipitate white polymer. The polymer is then reprecipitated from acetone and methanol.

### Example 18

This example describes synthesis of a rigid rod-like macromolecule of the general structural formula 12 in Table 2, wherein R₁ is CH₃ and M is Cs.

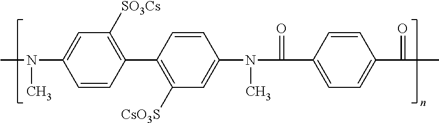

30 g 4,4′-Diaminobiphenyl-2,2′-disulfonic acid is mixed with 300 ml pyridine. 60 ml of acetyl chloride is added to the mixture with stirring and the resulting reaction mass agitated for 2 hrs at 35-45° C. Then it is filtered, the filter cake is rinsed with 50 ml of pyridine and then washed with 1200 ml of ethanol. The obtained alcohol wet solid is dried at 60° C. Yield of 4,4′-bis(acetylamino)biphenyl-2,2′-disulfonic acid pyridinium salt is 95%.

12.6 g 4,4′-bis(acetylamino)biphenyl-2,2′-disulfonic acid pyridinium salt is mixed with 200 ml DMF. 3.4 g sodium hydride (60% dispersion in oil) is added. The reaction mass is agitated 16 hrs at room temperature. 7.6 ml methyl iodide is added and the reaction mass is stirred 16 hrs at room temperature. Then the volatile components of the reaction mixture are distilled off and the residue washed with 800 ml of acetone and dried. The obtained 4,4′-bis[acetyl(methyl)amino]biphenyl-2,2′-disulfonic acid is dissolved in 36 ml of 4M sodium hydroxide. 2 g activated charcoal is added to the solution and stirred at 80° C. for 2 hrs. The liquid is clarified by filtration, neutralized with 35% HCl to pH˜1 and reduced by evaporation to ˜30% by volume. Then it is refrigerated (5° C.) overnight and precipitated material isolated and dried. Yield of 4,4′-bis[methylamino]biphenyl-2,2′-disulfonic acid is 80%.

2.0 g 4,4′-bis[methylamino]biphenyl-2,2′-disulfonic acid and 4.2 g cesium hydrocarbonate are mixed with 6 ml water. This solution is stirred with IKA UltraTurrax T25 at 5000 rpm for 1 min. 2 ml triethylene glycol dimethyl ether is added, followed by 4.0 ml of toluene with stirring at 20000 rpm for 1 min. Then solution of 1.2 g terephtaloyl chloride in 2.0 ml of toluene is added to the mixture at 20000 rpm. The emulsion of polymer is stirred for 60 min and then poured into 150 ml of ethanol at 20000 rpm. After 20 min of agitation the suspension of polymer is filtered on a Buchner funnel with a fiber filter, the resulting polymer dissolved in 8 ml of water, precipitated by pouring into of 50 ml of ethanol and dried 12 hrs at 70° C. Yield is 2.3 g.

Analytical control of synthesis and purity of final product (4,4′-bis[methylamino]biphenyl-2,2′-disulfonic acid) was carried out by ion-pair HPLC. HPLC analysis of the intermediate products and final product was performed with Hewlett Packard 1050 (Agilent, USA) system comprising automated sample injector, quatpump, thermostatted column compartment, diode array detector and ChemStation B10.03 software. Compounds were separated on a 15 cm×4.6 mm i.d., 5-μm particale, Dr. Maisch GmbH ReproSil—Pur Basic C18 column by use of a linear gradient prepared from acetonitrile (component A), water-solution of tetra-n-butylammonium bromide 0.01M (component B), and phosphate buffer 0.005M with pH=6.9-7.0 (component C). The gradient was: A-B-C 20:75:5 (v/v) to A-B-C 35:60:5 (v/v) in 20 min. The flow rate was 1.5 mL min⁻¹, the column temperature 30° C., and effluent was monitored by diode array detector at 230 and 300 nm.

### Example 19

This Example describes synthesis of natrium salt of the polymer shown in structure 17 in Table 2.

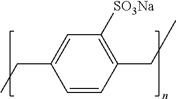

0.654 g of Copper (II) chloride (4.82 mmol, 0.07 eq) was dissolved into 410.0 ml (had been degassed by evacuated and filled with argon and then purging with argon) of water with stirring at ambient condition in 2500-ml beaker. 26.0 g of 2,5-bis-(bromomethyl)-benzenesulfonic acid (66.02 mmol) was added to the obtained solution and then 25.82 g of Sodium bromide (250.88 mmol, 3.8 eq) was added into whitish suspension. 115.5 ml of n-amyl alcohol was added to reaction mixture at vigorously stirring. 10.03 g of sodium borohydride (264.08 mmol, 4.0 eq) in 52.0 ml of water was added in one portion to reaction mixture at vigorously stirring. The resulting mixture was stirred for 10 min. The bottom water layer was isolated and this dark foggy solution was filtered through a double layer glass filter paper (D=185 mm). The resulting solution was filtered through a filter-membrane (Millipore, PHWP29325, mixed cellulose ester, 0.3 μm) used Stirred Ultrafiltration Cell. Water was evaporated and 24.1 g of dry polymer was obtained. (Mn=20536, Mw=130480, Pd=6.3).

### Example 20

This Example describes synthesis of natrium salt of the polymer shown in structure 29 in Table 2.

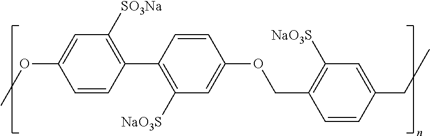

556 mg of 2,5-bis(bromomethyl)benzenesulfonic acid, 557 mg of 4,4′-dihydroxybiphenyl-2,2′-disulfonic acid and 500 mg of tetra-n-butylammonium bromide were dissolved in 10 ml of abs. N-methylpyrrolidone. 332 mg of 60% sodium hydride (5.1 eq.) was added by small portions to this solution and the mixture was stirred for 4 days at 50° C. After that, the mixture was poured into 100 ml of ethanol and filtered off. The precipitate was dissolved in water (˜5 ml) and precipitated into 100 ml of ethanol and filtered off again. It was obtained 340 mg of polymer with Mn=9K, Mw=15K.

### Example 21

This Example describes synthesis of natrium salt of the polymer shown in structure 28 in Table 2.

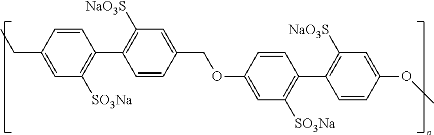

400 mg of 4,4′-bis(chloromethyl)biphenyl-2,2′-disulfonic acid, 337 mg of 4,4′-dihydroxybiphenyl-2,2′-disulfonic acid and 400 mg of tetra-n-butylammonium bromide were dissolved in 10 ml of abs. N-methylpyrrolidone. 238 mg of 60% sodium hydride (6.1 eq.) was added by small portions to this solution and the mixture was stirred for 4 days at 50° C. After that, the mixture was poured into 100 ml of ethanol and filtered off. The precipitate was dissolved in water (˜5 ml) and precipitated into 100 ml of ethanol and filtered off again. It was obtained 330 mg of polymer with Mn=3K, Mw=5K.

Synthesis of Monomer for this Polymer was Done as Follows:

### Intermediate Step 1:

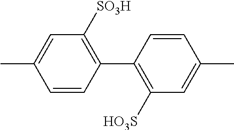

2-iodo-5-methylbenzenesulfonic acid (46 g, 137 mmol) was placed into a two-neck flask (volume 500 mL) and water (200 mL) was added. Blue copperas copper sulfate (0.25 g, 1 mmol) in water (40 mL) was added to resultant solution and mixture obtained was heated to 85° C. for 15 min. Copper powder was added (14. g, 227 mmol) to dark solution. Temperature rose to 90° C., then reaction mixture was stirred for 3 h at 80-85°.

Reaction mixture was filtered twice, solution was concentrated to 75 mL on a rotary evaporator, cooled to 0° C. and ethanol was added dropwise (25 mL). Precipitate formed was filtered off and washed with ethanol and dried at 50° C. Yield 28 g.

### Intermediate Step 2:

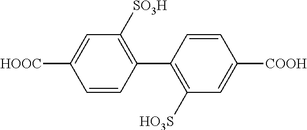

4,4′-dimethylbiphenyl-2,2′-disulfonic acid (30.0 g, 71.7 mmol) was dissolved in water (600 mL), and sodium hydroxide was added (12 g, 300 mmol). Resultant solution was heated to 45-50° C. and potassium permanganate was added (72 g, 45 mmol) in portions for 1 h 30 min. Resultant mixture was stirred for 16 h at 50-54° C. then cooled to 40° C., methanol was added (5 mL), temperature rose to 70° C. upon the addition. Mixture was cooled to 40° C., filtered from manganese oxide, clear colorless solution was concentrated to 100 mL acidified with hydrochloric acid (50 mL). Resultant mixture was left overnight, cooled to 0° C. and filtered off, washed with acetonitrile (100 mL, re-suspension) and diethylether, dried, 13.5 g fibrous white solid.

### Intermediate Step 3:

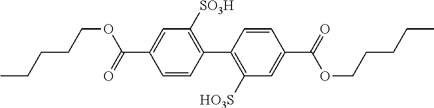

2,2′-disulfobiphenyl-4,4′-dicarboxylic acid (7.5 g, 18.6 mmol) was mixed with n-pentanol (85 mL, 68 g, 772 mmol) and sulfuric acid (0.5 mL) and heated under reflux with Dean-Stark trap for 3 h more. Reaction mixture was cooled to 50° C., diluted with hexane (150 mL), stirred at the same temperature for 10 min, precipitate was filtered off and washed with hexane (3×50 mL) then dried at 50° C. for 4 h. Weight 8.56 g (84%) as white solid.

### Intermediate Step 4:

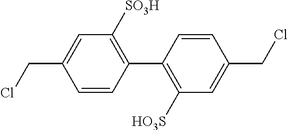

Anhydrous tetrahydrofuran (400 mL) was placed into a flask supplied with condenser, magnetic stirrer, thermometer and argon T-tube. Lithium alumohydride (3.5 g, 92 mmol) was added to tetrahydrofuran, resultant suspension was heated to 50° C. and 4,4′-bis[(pentyloxy)carbonyl]biphenyl-2,2′-disulfonic acid was added in portions for 10 min with efficient stirring (20.0 g, 37 mmol). Resultant suspension was mildly boiled under reflux (63-64° C.) for 1.5 h.

Reaction mixture was cooled to 10° temperature (ice-water) and water was added with stirring until hydrogen evolution ceased (5-5.2 mL), mixture was diluted with anhydrous tetrahydrofuran (100 mL) to make stirring efficient. Resultant white suspension was transferred to a flask of 1 L volume, acidified with hydrochloric acid 36% (24 g). Sticky precipitate formed. It was well-stirred with a glass rod and mixture was taken to dryness on a rotary evaporator, residue was mixed with anhydrous tetrahydrofuran (100 mL), solvent removed on a rotary evaporator, white solid residue was dried in a drying pistol at 67° C./10 mm Hg (boiling methanol) for 2 h. White pieces were powdered and dried for 1 h more Resultant weight 30 g, white powder. Calculated product content approx 1.25 mmol/g (50%) of diol in the mixture of inorganic salts (AlCl₃, LiCl) and solvating water.

Crude 4,4′-bis(hydroxymethyl)biphenyl-2,2′-disulfonic acid (3.0 g, 3 mmol) was mixed with hydrochloric acid 36% (10 mL) and stirred at bath temperature of 85° C. for 1.5 h. Gas hydrogen chloride was passed though reaction mixture twice for 10 minutes after 15 and 1 h 20 minutes of heating. Clear solution did not formed but almost clear suspension was observed. Reaction mixture was cooled to 0° with ice-water bath, stirred unde a flow of hydrochloric acid at this temperature and white precipitate was filtered off and dried over potassium hydroxide overnight in vacuo. Weight 2.6 g.

### Example 22

This Example describes synthesis of natrium salt of the polymer shown in structure 27 in Table 2.

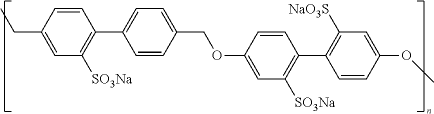

100 mg of 4,4′-bis(bromomethyl)biphenyl-2-sulfonic acid, 83 mg of 4,4′-dihydroxybiphenyl-2,2′-disulfonic acid and 80 mg of tetra-n-butylammonium bromide were dissolved in 2 ml of abs. N-methylpyrrolidone. 50 mg of 60% sodium hydride (5.1 eq.) was added by small portions to this solution and the mixture was stirred for 4 days at 50° C. After that, the mixture was poured into 20 ml of ethanol and filtered off. The precipitate was dissolved in water (˜2-3 ml) and precipitated into 50 ml of ethanol and filtered off again. It was obtained 100 mg of polymer with Mn=10K, Mw=23K.

Synthesis of Monomer for this Polymer was Done as Follows:

### Intermediate Step 5:

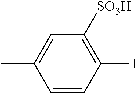

2-Sulfo-p-toluidine (50 g, 267 mmol) was mixed with water (100 mL) and hydrochloric acid 36% (100 mL). The mixture was stirred and cooled to 0° C. A solution of sodium nitrite (20 g, 289 mmol) in water (50 mL) was added slowly (dropping funnel, 1.25 h) keeping temperature at 3-5° C. Then resultant suspension was stirred for 1 h 45 min at 0-3° C., filtration afforded dark mass which was added wet in portions into tall beaker supplied with a magnetic stirrer and thermometer containing potassium iodide (66.5 g, 400 mmol) dissolved in 25% sulfuric acid (212 mL) temperature was kept around 10° C. during the addition. A lot of nitrogen evolved, foaming, big magnetic bar required. Then reaction mixture was warmed to room temperature and 25% solution of sulfuric acid (200 mL) was added. Heating was continued at 70° C. for 30 min and 25% solution of sulfuric acid (150 mL) was added and stirred for a while. Mixture was hot filtered from black insoluble solids, cooled to room temperature with stirring. A precipitate formed, solution was dark. Precipitate was filtered on a Pall glass sheet, washed with ethanol-water 1:1 (100 mL), re-suspended (ethanol 100 mL) and filtered once again, washed on the filter with ethanol (50 mL) and dried in a stove at 50° C., resultant compound is pale-brown. Yield 46 g (57%).

### Intermediate Step 6:

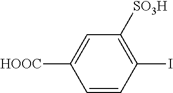

In one-neck flask (volume 1 L) water was placed (500 mL) followed by sodium hydroxide (6.5 g, 160 mmol) and 3-sulfo-4-iodotoluene (20.0 g, 67.1 mmol). Resultant solution was warmed up to 40° C. and finely powdered potassium permanganate (31.8 g, 201 mmol) was introduced in small portions at intervals of 10 min into well stirred liquid. Addition was carried out for 1 h 30 min. Temperature was kept at 40-45° C. (bath) during addition. Then reaction mixture was heated up to 75-80° C. (bath) and left for 16 h at this temperature. A mixture of methanol-water 1:1 (5.5 mL) was added at 60° C., dark suspension was cooled to 35-40° C. and filtered off. Clear transparent solution was acidified with hydrochloric acid 36% (130 mL) and concentrated on a rotary evaporator distilling approx. ⅓ of the solvent. White precipitate formed. Suspension was cooled on ice, filtered off, washed with acetonitrile (50 mL) and diethylether (50 mL). White solid was dried in a stove at 50° C. until smell of hydrochloric acid disappeared (4 h). Weight 22 g.

### Intermediate Step 7:

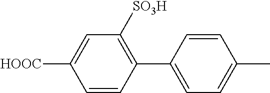

Water (550 mL) was placed into a flask equipped with thermometer, magnetic stirrer, argon inlet tube and bubble counter, heated to 40° C., potassium carbonate was added (40.2 g, 291 mmol), followed by 4-iodo-3-sulfobenzoic acid (19.1 g, 58.3 mmol) and 4-methylphenylboronic acid (8.33 g, 61.2 mmol). Solution formed. Apparatus was evacuated and filled with argon 4 times with stirring. Pd/C 10% (Aldrich, 1.54 mg, 1.46 mmol) was added and apparatus was flashed with argon 3 times more. Temperature of solution was rose to 75-80° and resultant mixture (transparent except for C) was stirred for 16 h under argon atmosphere. Reaction mixture was cooled to 40° C., filtered twice (PALL), hydrochloric acid 36% was added drop wise (ice bath) until CO₂ evolution seized and a little bit more (55 g). Suspension resultant was cooled on ice, filtered off, washed in a beaker with acetonitrile (50 ml), filtered and washed with diethylether (50 mL) on the filter, then dried in a stove for 3 h at 45° C. Yield 10.0 g (58%).

### Intermediate Step 8:

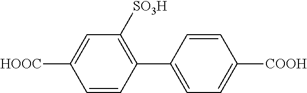

In two-neck flask (volume 0.5 L) water was placed (500 mL) followed by sodium hydroxide (4.4 g, 109 mmol) and 4′-methyl-2-sulfobiphenyl-4-carboxylic acid (10.0 g, 34.2 mmol). Resultant solution was warmed up to 40° C. (oil bath, inner temperature) and finely powdered potassium permanganate (16.2 g, 102.6 mmol) was introduced in small portions at intervals of 10 min into well stirred liquid. Addition was carried out for 45 min. Temperature was kept at 40-45° C. (bath) during addition. Then reaction mixture was heated up to 50° C. (inner) and left for 18 h at this temperature with stirring. A mixture of methanol-water 1:1 (2 mL) was added at 45° C., dark suspension was cooled to r.t. and filtered off. Clear transparent solution was acidified with hydrochloric acid 36% (13 g). White precipitate formed. Suspension was cooled on ice, filtered off, washed with acetonitrile (50 mL) in a beaker, filtered and washed with diethylether. (50 mL) on the filter. White solid was dried in a stove at 50° C. until smell of hydrochloric acid disappeared (4 h). Weight 7.5 g (68%)

### Intermediate Step 9:

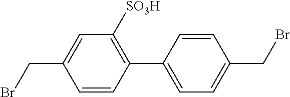

Powdered 2-sulfobiphenyl-4,4′-dicarboxylic acid (7.5 g, 23.3 mmol) was mixed with anhydrous (dist. over magnesium) methanol (100 mL) and sulfuric acid (d 1.84, 2.22 mL, 4.0 g, 42.6 mmol). Resultant suspension was left with stirring and mild boiling for 2 days. Sodium carbonate (5.01 g, 47.7 mmol) was added to methanol solution and stirred for 45 min then evaporated on a rotary evaporator. Residue (white powder) was mixed with tetrahydrofuran to remove any big particles (100 mL) and resultant suspension was dried on a rotary evaporator, then in a dessicator over phosphorus oxide under reduced pressure overnight. Resultant residue was used in further transformation as it is.

A one-neck flask (volume 250 mL) containing dried crude 4,4′-bis(methoxycarbonyl)biphenyl-2-sulfonic acid and magnetic stirrer and closed with a stopper was filled with tetrahydrofuran (anhydrous over sodium, 150 mL). White suspension was stirred for 20 min ar r.t. to insure its smoothness then lithium alumohydride was added in portions (0.2-0.3 g) for 40 min. Exothermic effect was observed. Temperature rose to 45-50° C. Then joints were cleaned with soft tissue and flask was equipped with condenser and argon bubble T-counter. Resultant suspension was heated with stirring (bath 74° C.) for 3 h.

Reaction mixture was cooled to 10° C. on ice, and water was added drop wise until hydrogen evolution (COUTION!) seized (4 mL). Hydrobromic acid (48%) was added in small portions until suspension became milky (43 g, acid reaction of indicator paper). The suspension was transferred to flask of 0.5 L volume and it was taken to almost to dryness on a rotary evaporator. Hydrobromic acid 48% was added to the flask (160 mL), resultant muddy solution was filtered (PALL) and flask was equipped with h-tube with a thermometer and argon inlet tube. Apparatus was flashed with argon and placed on an oil bath. Stirring was carried out while temperature (inner) was rose to 75° C. for 15 min. After 7 minutes at this temperature formation of white precipitate was observed. Stirring was carried out for 1.5 h at 70-75° C., then suspension was cooled to 30° C., filtered off, precipitate was washed with cold hydrobromic acid 48% (30 mL) on the filter, and pressed to some extent. Filter cake was dried over sodium hydroxide in a dessicator under reduced pressure periodically filling it with argon. Weight 7.0 g (72% on diacid).

What is claimed is:

1. A retarder comprising
at least one substrate, and
at least one retardation layer coated onto the substrate,
wherein the substrate possesses an anisotropic property of positive A-type,
wherein the retardation layer is substantially transparent to electromagnetic radiation in the visible spectral range, and
wherein a principal axis of the lowest refractive index of the retardation layer and the principal axis of the largest refractive index of the substrate are substantially parallel to each other.

2. A retarder according to claim 1, wherein the material of the substrate is birefringent and is selected from the list comprising poly ethylene terephtalate (PET), poly ethylene naphtalate (PEN), polyvinyl chloride (PVC), polycarbonate (PC), poly propylene (PP), poly ethylene (PE), polyimide (PI), and poly ester.

3. A retarder according to claim 1, wherein a type of the retardation layer is selected from the list comprising negative A-type and B_{A}-type.

4. A retarder according to claim 3, wherein the retardation layer of the B_{A}-type and negative A-type comprises at least one organic compound of a first type or its salt, and at least one organic compound of a second type,
wherein the organic compound of the first type has the general structural formula I 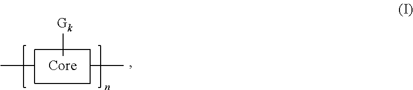
where Core is a conjugated organic unit capable of forming a rigid rod-like macromolecule, n is a number of the conjugated organic units in the rigid rod-like macromolecule which is equal to integers in the range from 10 to 10000, Gₖ is a set of ionogenic side-groups, and k is a number of the side-groups in the set Gₖ, k is a number of the side-groups in the set Gₖ₁ which is equal to 0, 1, 2, 3, 4, 5, 6, 7, or 8; and wherein the organic compound of the second type has the general structural formula II 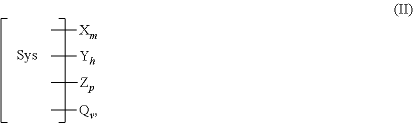
where Sys is at least partially conjugated substantially planar polycyclic molecular system; X, Y, Z, Q and R are substituents; substituent X is a carboxylic group —COOH, m is 0, 1, 2, 3 or 4; substituent Y is a sulfonic group —SO₃H, h is 0, 1, 2, 3 or 4; substituent Z is a carboxamide —CONH₂, p is 0, 1, 2, 3 or 4; substituent Q is a sulfonamide —SO₂NH₂, v is 0, 1, 2, 3 or 4; wherein the organic compound of the second type forms board-like supramolecules via π-π-interaction, and a composition comprising the compounds of the first and the second types forms lyotropic liquid crystal in a solution with suitable solvent.

5. A retarder according to claim 4, wherein the organic compound of the first type is selected from the structures 1 to 29: 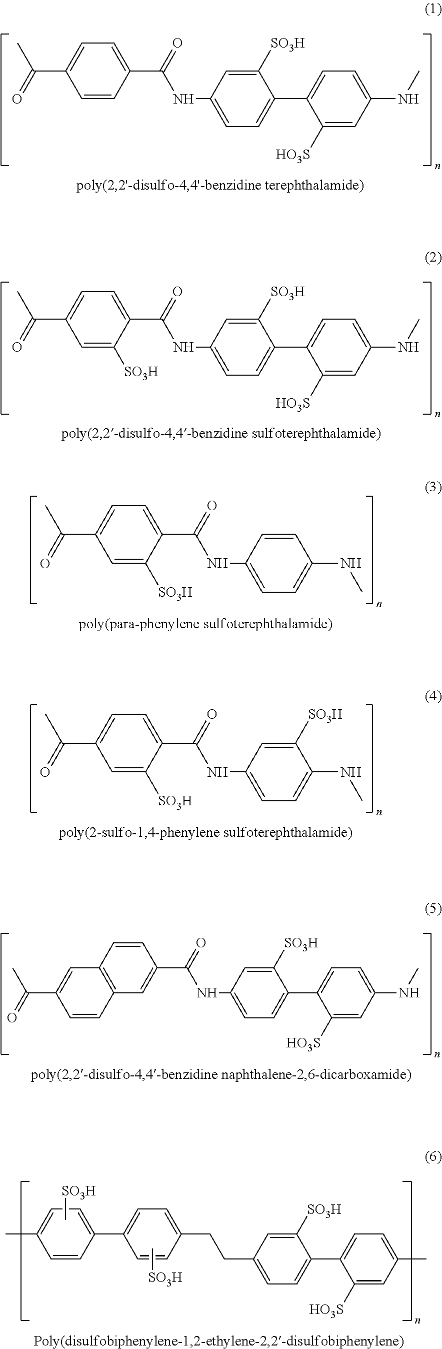 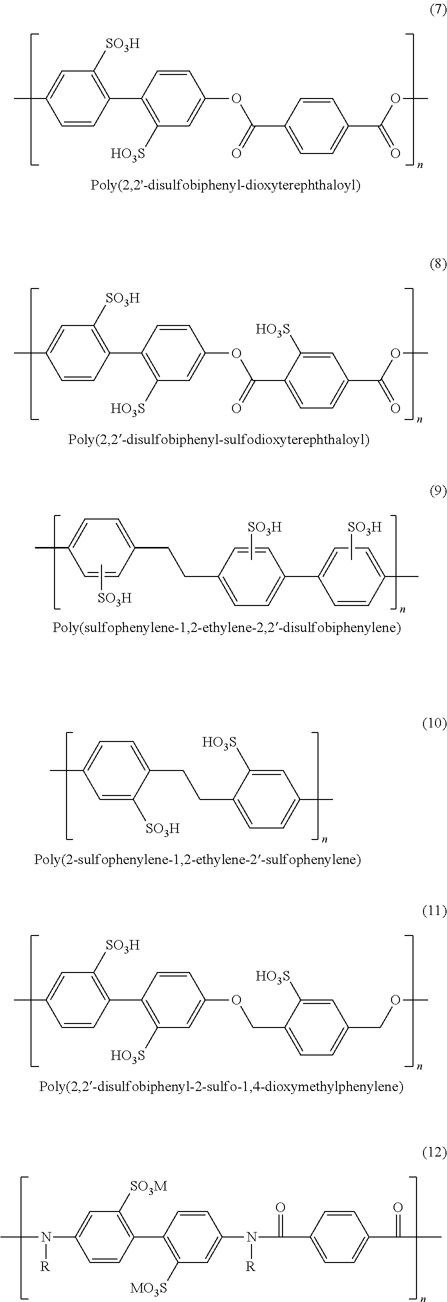 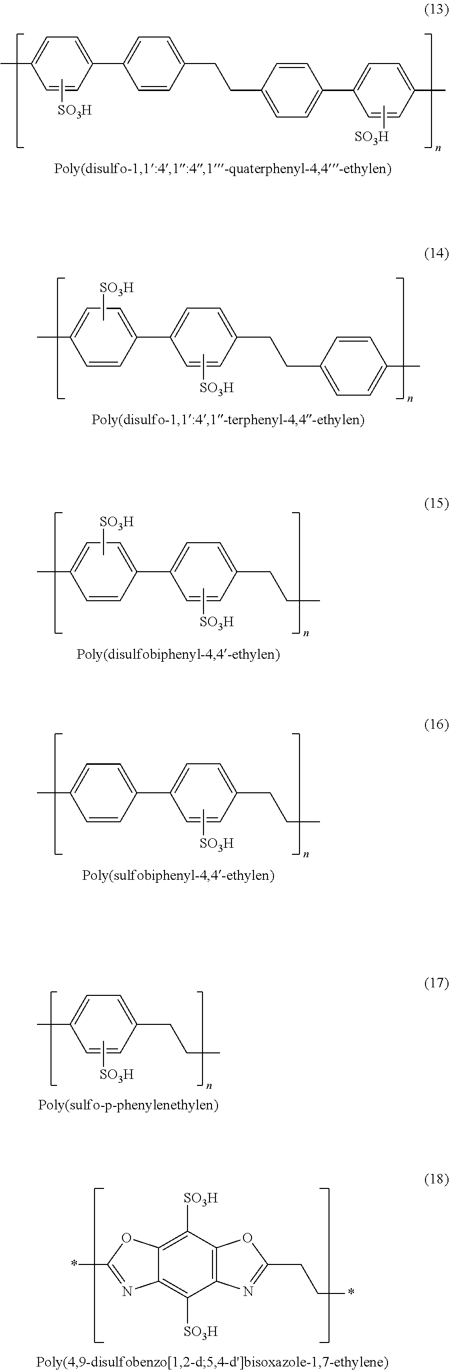 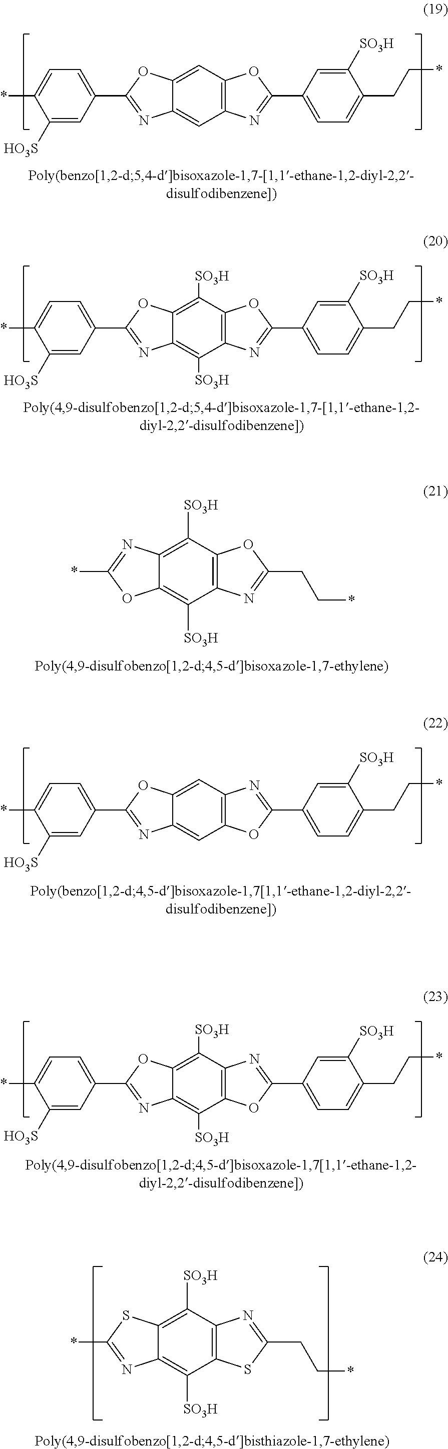 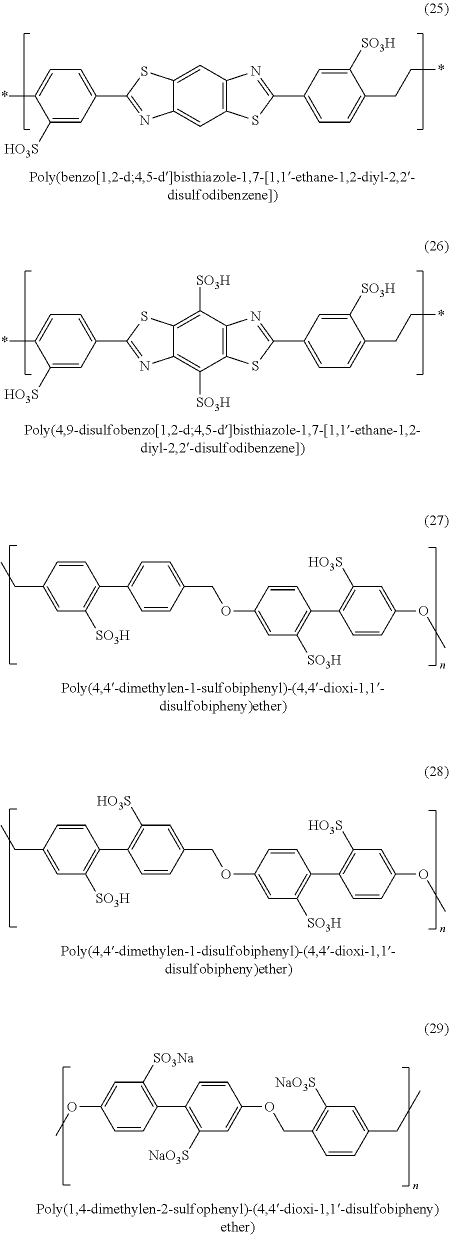
where R is a side-group selected from the list comprising Alkil, (CH₂)ₘSO₃H, (CH₂)ₘSi(O Alkyl)₃, CH₂Phenyl, (CH₂)ₘOH and M is counterion selected from the list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, Zr⁴⁺ and NR₄₋ₖQₖ⁺, where Q is selected from the list comprising linear and branched (C1-C20) alkyl, (C2-C20) alkenyl, (C2-C20) alkinyl, and (C6-C20)arylalkyl, and k is 0, 1, 2, 3 or 4.

6. A retarder according to claim 4, wherein the organic compound of the first type further comprises additional side-groups independently selected from the list comprising linear and branched (C1-C20)alkyl, (C2-C20)alkenyl, and (C2-C20)alkinyl.

7. A retarder according to claim 6, wherein at least one of the additional side-groups is connected with the conjugated organic unit Core via a bridging group A selected from the list comprising —C(O)—, —C(O)O—, —C(O)—NH—, —(SO₂)NH—, —O—, —CH₂O—, —NH—, >N—, and any combination thereof.

8. A retarder according to claim 4, wherein the salt of the organic compound of the first type is selected from the list comprising ammonium and alkali-metal salts.

9. A retarder according to claim 4, wherein the organic compound of the second type has at least partially conjugated substantially planar polycyclic molecular system Sys selected from the structures of the general formulas 30 to 44:

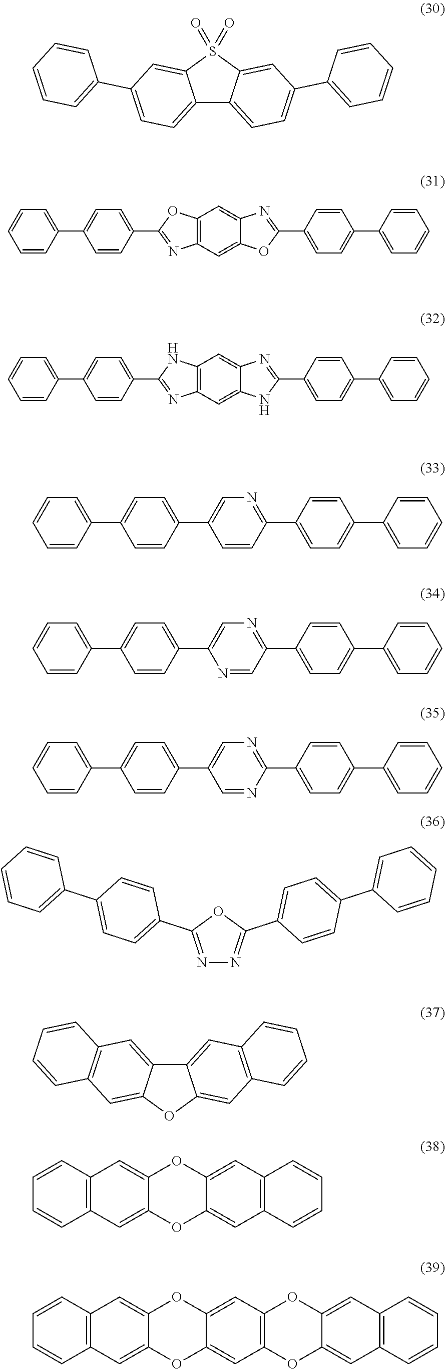

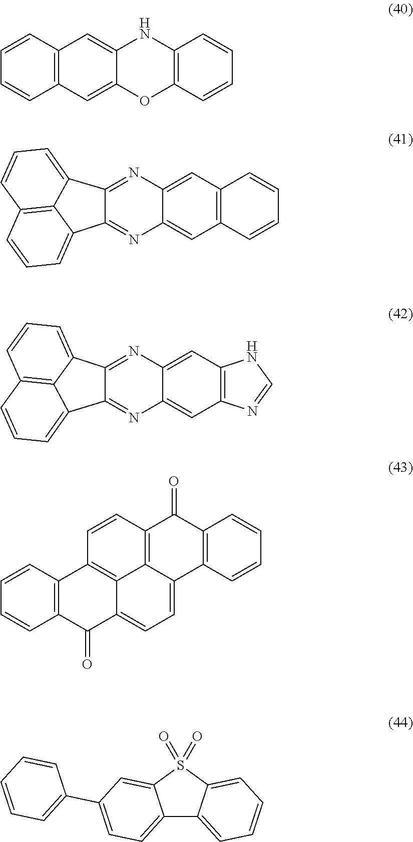

10. A retarder according to claim 9, wherein the organic compound of the second type is selected from the structures 45 to 53, where the molecular system Sys is selected from the structures 30 and 37 to 44, the substituent is a sulfonic group —SO₃H, and m1, p1, and v1 are equal to 0:

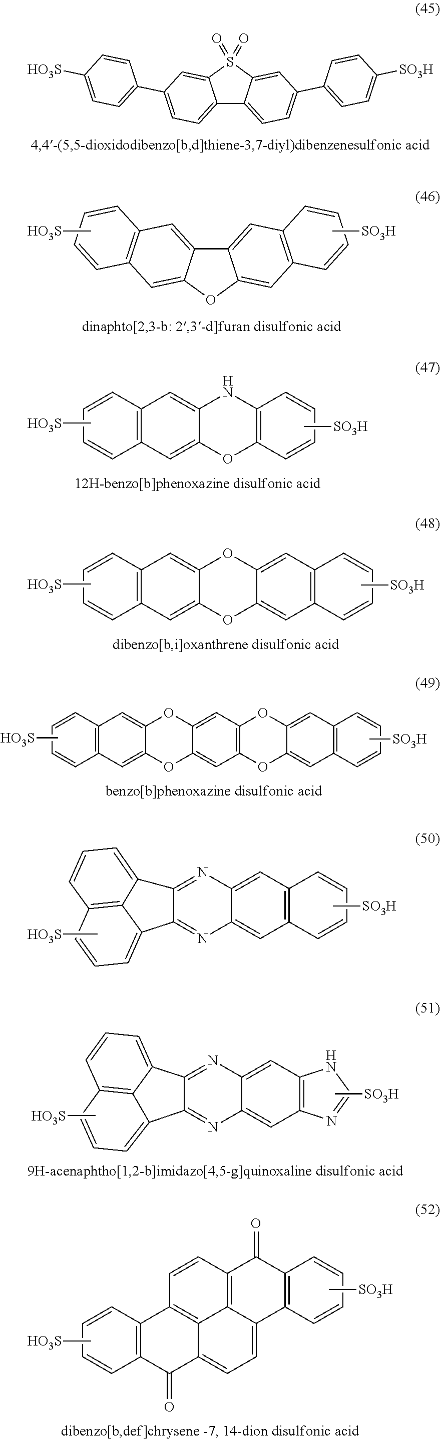

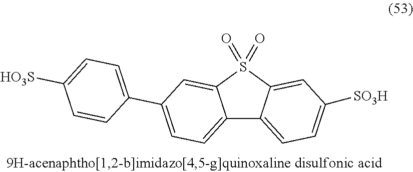

11. A retarder according to claim 4, wherein the organic compound of the second type further comprises at least one substituent selected from the list comprising CH₃, C₂H₅, Cl, Br, NO₂, F, CF₃, CN, OH, OCH₃, OC₂H₅, OCOCH₃, OCN, SCN, and NHCOCH₃.

12. A retarder according to claim 1, wherein the substrate comprises a non-birefringent layer and a positive A-type retardation layer.

13. A retarder according to claim 12, wherein a material of the non-birefringent layer is selected from the list comprising triacetyl cellulose (TAC), cyclic olefin polymer (COP), Acrylic, and Z-TAC.

14. A retarder according to claim 12, wherein the positive A-type retardation layer comprises the organic compound which is selected from structures 1-29: 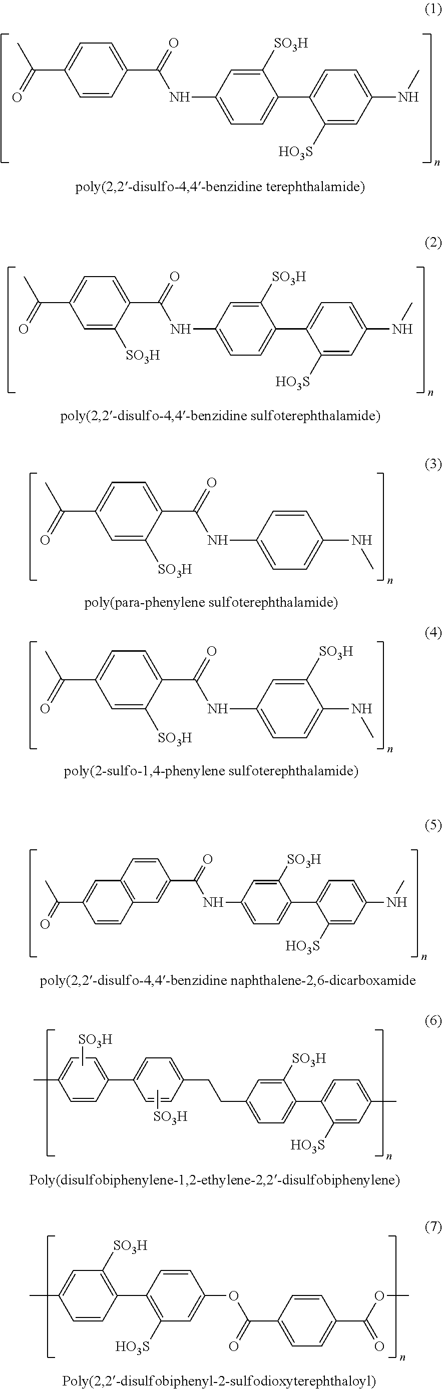 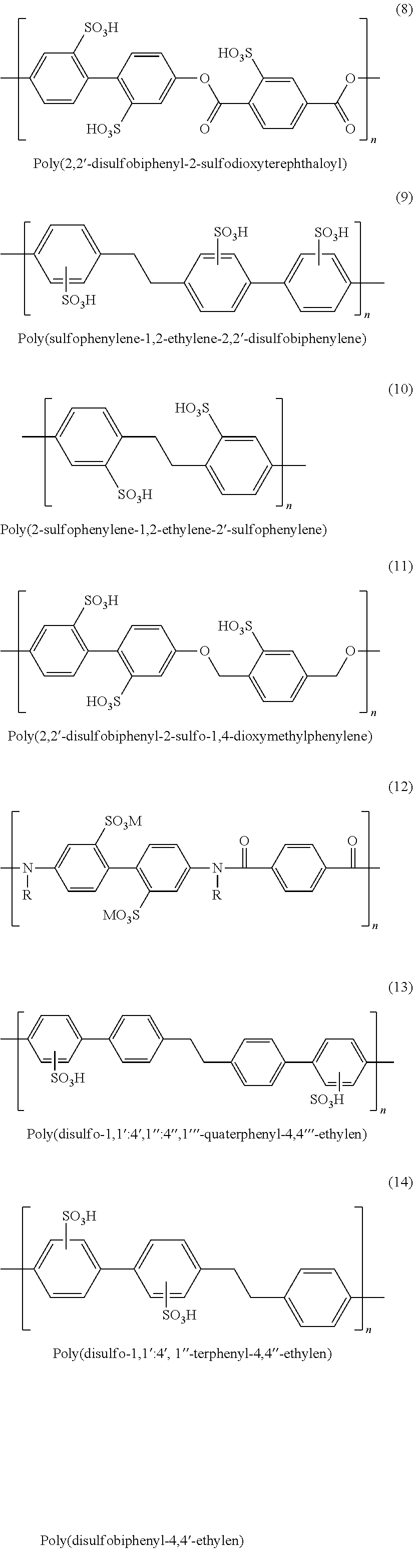 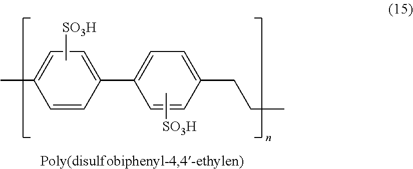 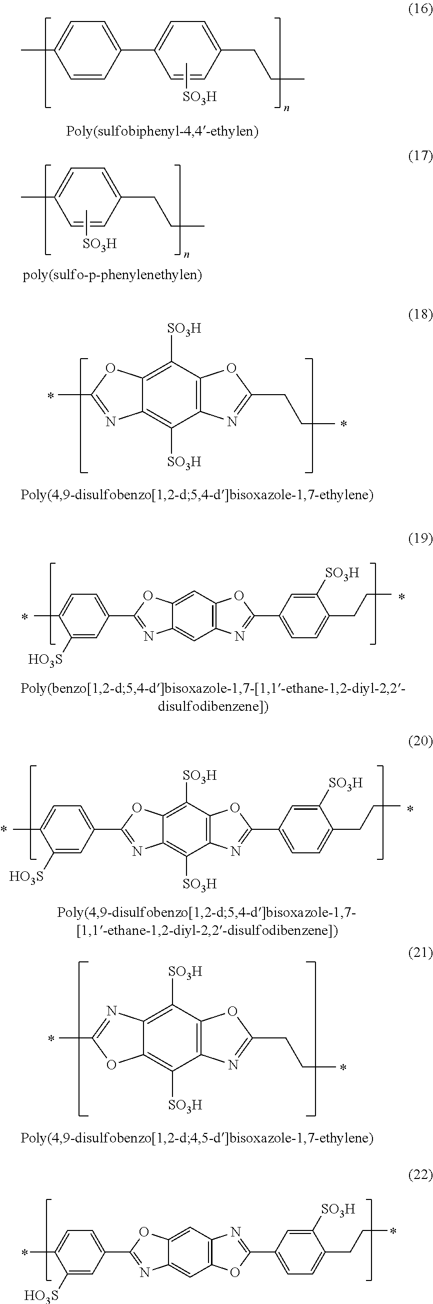 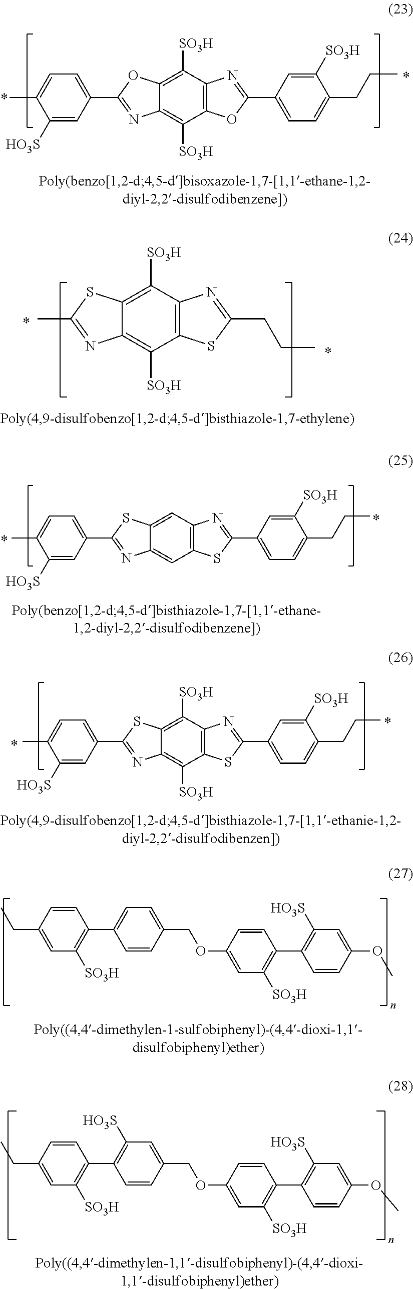 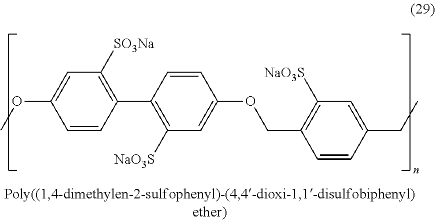
where R is a side-group selected from the list comprising Alkil, (CH₂)ₘSO₃H, (CH₂)ₘSi(O Alkyl)₃, CH₂Phenyl, (CH₂)ₘOH and M is counterion selected from the list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, Zr⁴⁺ and NR₄₋ₖQₖ⁺, where Q is selected from the list comprising linear and branched (C1-C20) alkyl, (C2-C20) alkenyl, (C2-C20) alkinyl, and (C6-C20)arylalkyl, and k is 0, 1, 2, 3 or 4.

15. A liquid crystal display comprising
a liquid crystal cell,
first and second polarizers arranged on each side of the liquid crystal cell, and
at least one retarder located between said polarizers
wherein the retarder comprises
at least one substrate, and
at least one retardation layer coated onto the substrate,
wherein the substrate possesses an anisotropic property of positive A-type, the retardation layer is substantially transparent to electromagnetic radiation in the visible spectral range, and
a principal axis of the lowest refractive index of the retardation layer and the principal axis of the largest refractive index of the substrate are substantially parallel to each other.

16. A liquid crystal display according to claim 15, wherein the liquid crystal cell is an in-plane switching mode liquid crystal cell.

17. A liquid crystal display according to claim 15, wherein the liquid crystal cell is a vertically-aligned mode liquid crystal cell.

18. A liquid crystal display according to claim 15, wherein the retarder is located inside the liquid crystal cell.

19. A liquid crystal display according to claim 15, wherein the retarder is located outside the liquid crystal cell.

20. A liquid crystal display according to claim 15, wherein the material of the substrate is birefringent and is selected from the list comprising poly ethylene terephtalate (PET), poly ethylene naphtalate (PEN), polyvinyl chloride (PVC), polycarbonate (PC), poly propylene (PP), poly ethylene (PE), polyimide (PI), and poly ester.

21. A liquid crystal display according to claim 15, wherein a type of the retardation layer is selected from the list comprising negative A-type and B_{A}-type.

22. A liquid crystal display according to claim 21, wherein the retardation layer of the B_{A}-type and negative A-type comprise at least one organic compound of a first type or its salt, and at least one organic compound of a second type,
wherein the organic compound of the first type has the general structural formula I 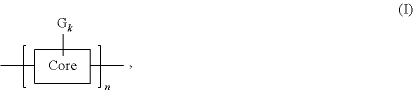
where Core is a conjugated organic unit capable of forming a rigid rod-like macromolecule, n is a number of the conjugated organic units in the rigid rod-like macromolecule which is equal to integers in the range from 10 to 10000, Gₖ is a set of ionogenic side-groups, and k is a number of the side-groups in the set Gₖ, k is a number of the side-groups in the set Gₖ₁ which is equal to 0, 1, 2, 3, 4, 5, 6, 7, or 8; and wherein the organic compound of the second type has the general structural formula II 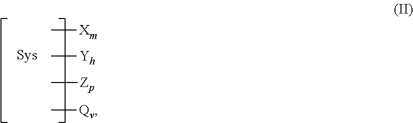
where Sys is at least partially conjugated substantially planar polycyclic molecular system; X, Y, Z, Q and R are substituents; substituent X is a carboxylic group —COOH, m is 0, 1, 2, 3 or 4; substituent Y is a sulfonic group —SO₃H, h is 0, 1, 2, 3 or 4; substituent Z is a carboxamide —CONH₂, p is 0, 1, 2, 3 or 4; substituent Q is a sulfonamide —SO₂NH₂, v is 0, 1, 2, 3 or 4; wherein the organic compound of the second type forms board-like supramolecules via π-π-interaction, and a composition comprising the compounds of the first and the second types forms lyotropic liquid crystal in a solution with suitable solvent.

23. A liquid crystal display according to claim 22, wherein the organic compound of the first type is selected from the structures 1 to 29: 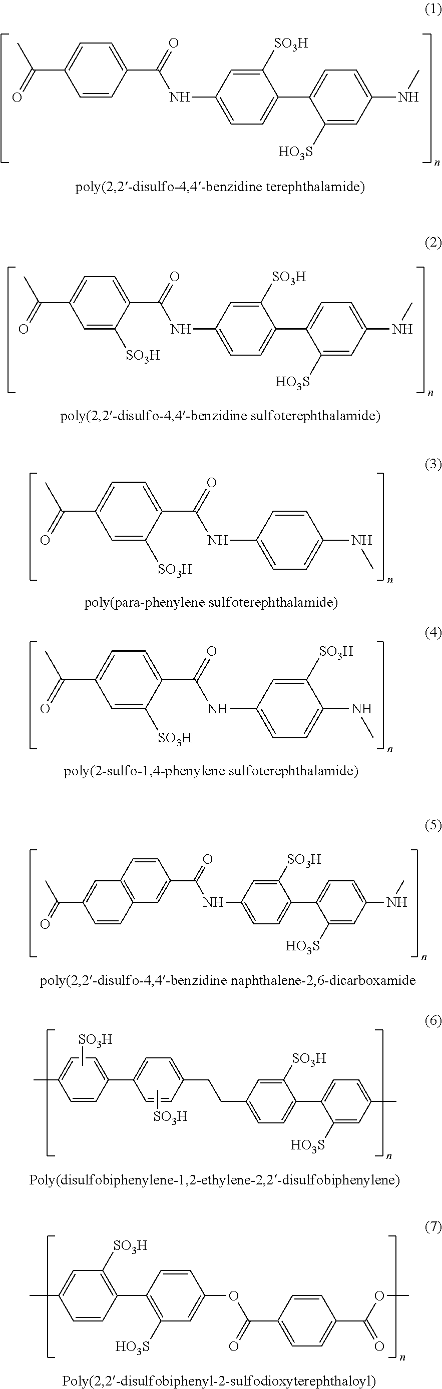 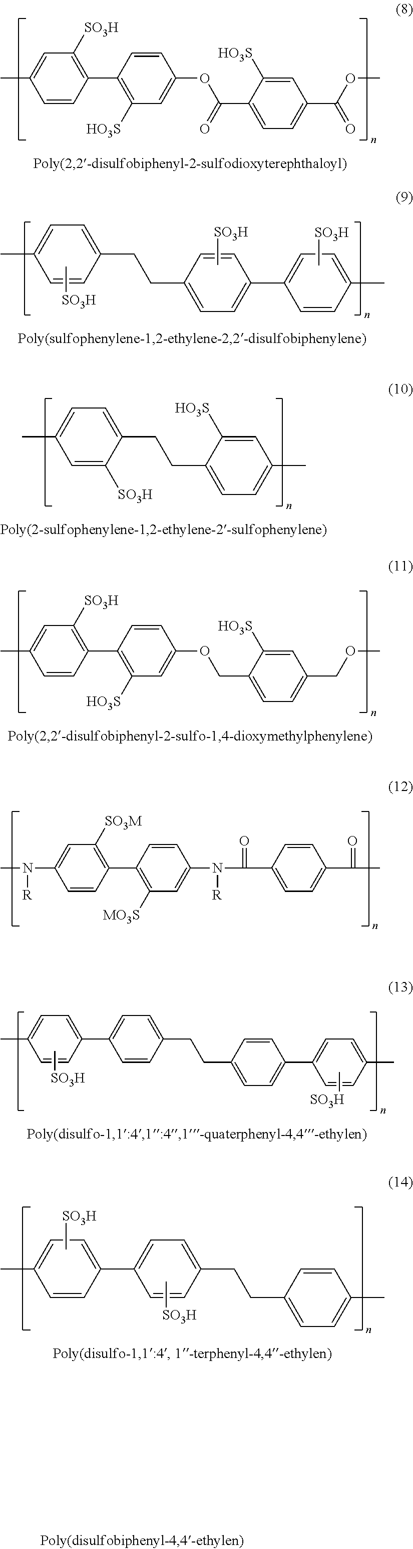 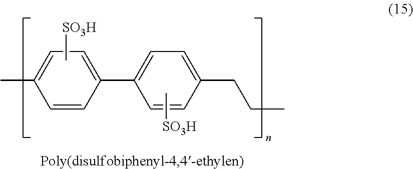 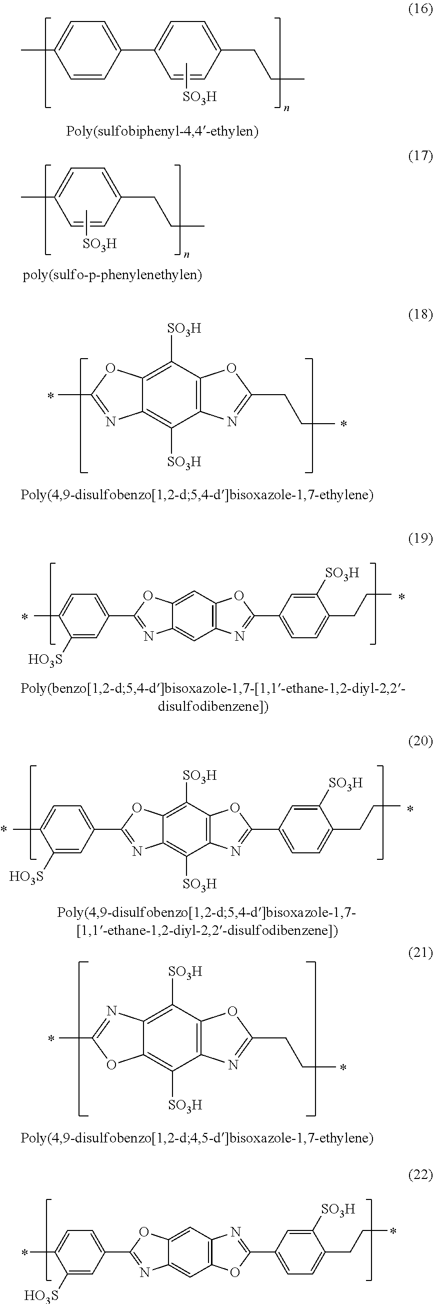 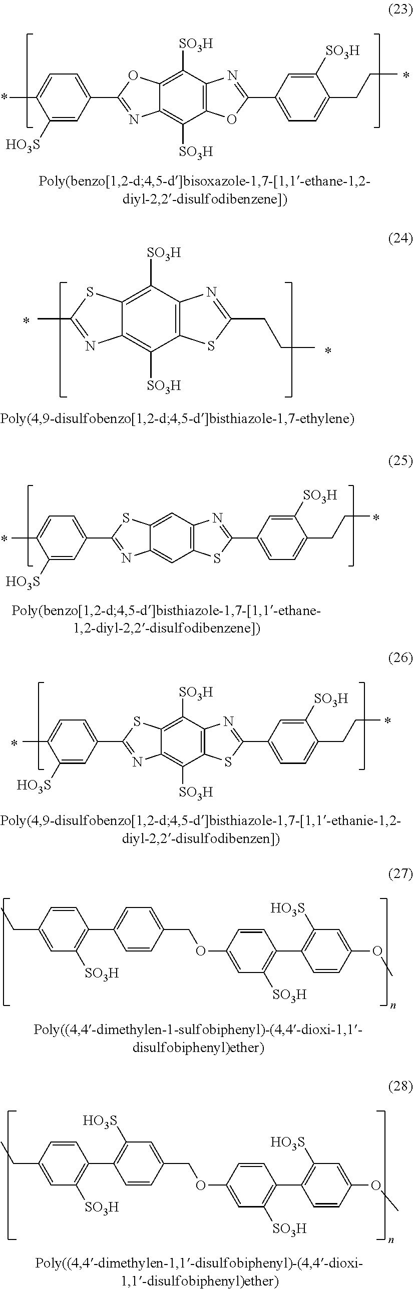 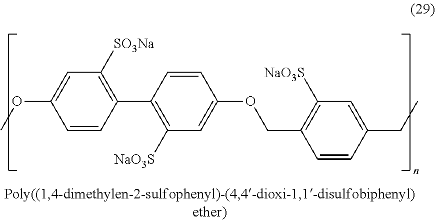
where R is a side-group selected from the list comprising Alkil, (CH₂)ₘSO₃H, (CH₂)ₘSi(O Alkyl)₃, CH₂Phenyl, (CH₂)ₘOH and M is counterion selected from the list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, Zr⁴⁺ and NR₄₋ₖQₖ⁺, where Q is selected from the list comprising linear and branched (C1-C20) alkyl, (C2-C20) alkenyl, (C2-C20) alkinyl, and (C6-C20)arylalkyl, and k is 0, 1, 2, 3 or 4.

24. A liquid crystal display according to claim 22, wherein the organic compound of the first type further comprises additional side-groups independently selected from the list comprising linear and branched (C1-C20)alkyl, (C2-C20)alkenyl, and (C2-C20)alkinyl.

25. A liquid crystal display according to claim 24, wherein at least one of the additional side-groups is connected with the conjugated organic unit Core via a bridging group A selected from the list comprising —C(O)—, —C(O)O—, —C(O)—NH—, —(SO₂)NH—, —O—, —CH₂O—, —NH—, >N—, and any combination thereof.

26. A liquid crystal display according to claim 22, wherein the salt of the organic compound of the first type is selected from the list comprising ammonium and alkali-metal salts.

27. A retarder according to claim 22, wherein the organic compound of the second type has at least partially conjugated substantially planar polycyclic molecular system Sys selected from the structures of the general formulas 30 to 44:

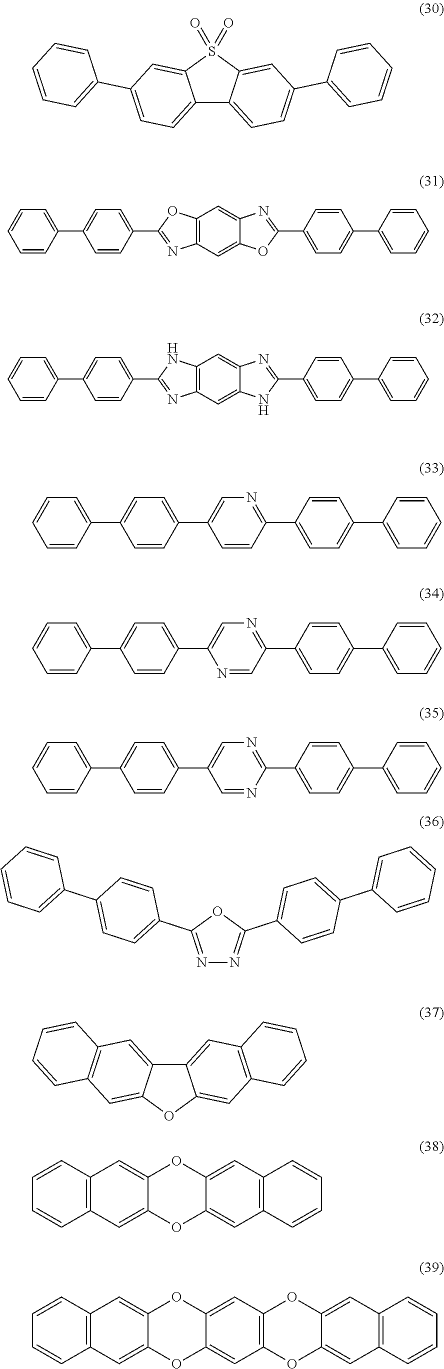

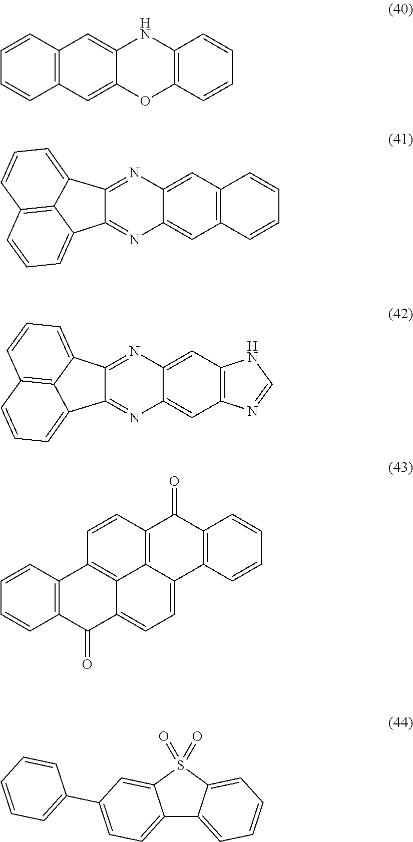

28. A retarder according to claim 22, wherein the organic compound of the second type is selected from the structures 45 to 53, where the molecular system Sys is selected from the structures 30 and 37 to 44, the substituent is a sulfonic group —SO₃H, and m1, p1, and v1 are equal to 0:

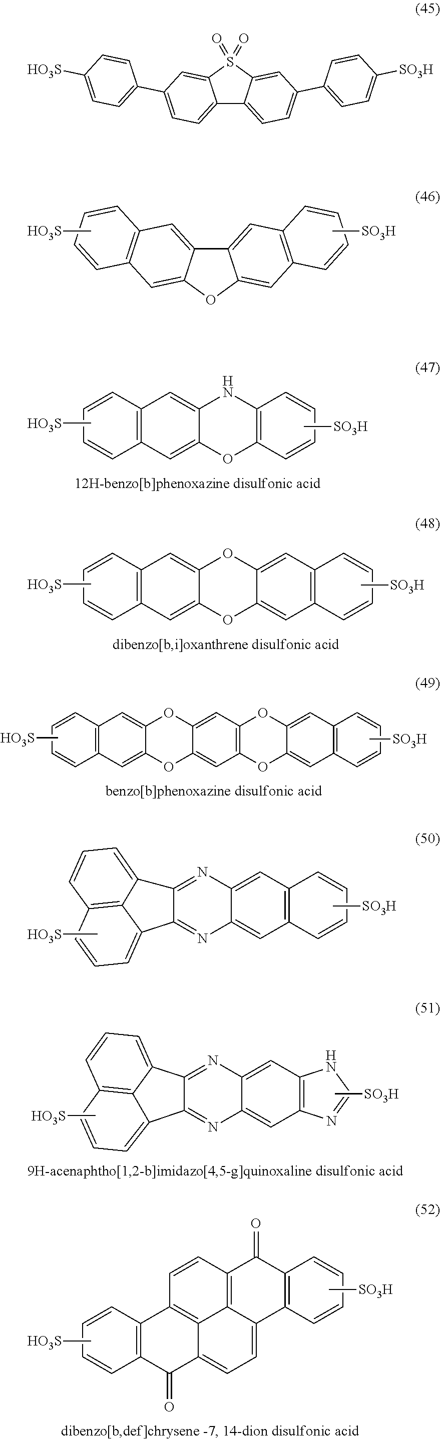

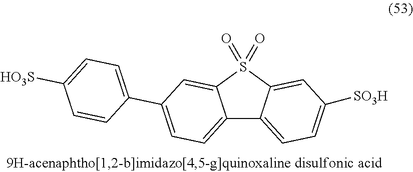

29. A retarder according to claim 22, wherein the organic compound of the second type further comprises at least one substituent selected from the list comprising CH₃, C₂H₅, Cl, Br, NO₂, F, CF₃, CN, OH, OCH₃, OC₂H₅, OCOCH₃, OCN, SCN, and NHCOCH₃.

30. A retarder according to claim 15, wherein the substrate comprises a non-birefringent layer and a positive A-type retardation layer.

31. A retarder according to claim 30, wherein a material of the non-birefringent layer is selected from the list comprising triacetyl cellulose (TAC), cyclic olefin polymer (COP), Acrylic, and Z-TAC.

32. A retarder according to claim 30, wherein the positive A-type retardation layer comprises the organic compound which is selected from structures 1-29: 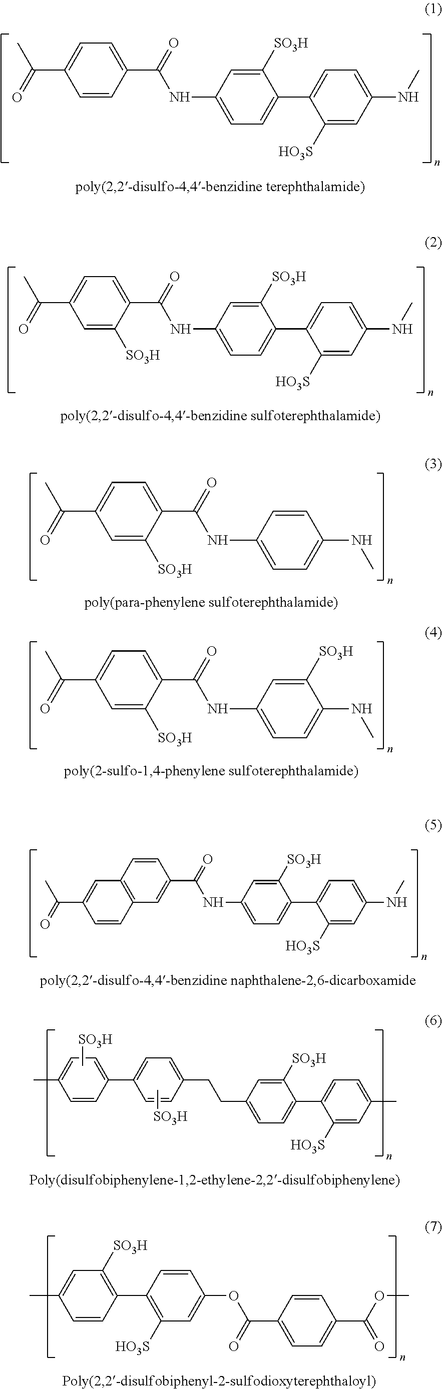 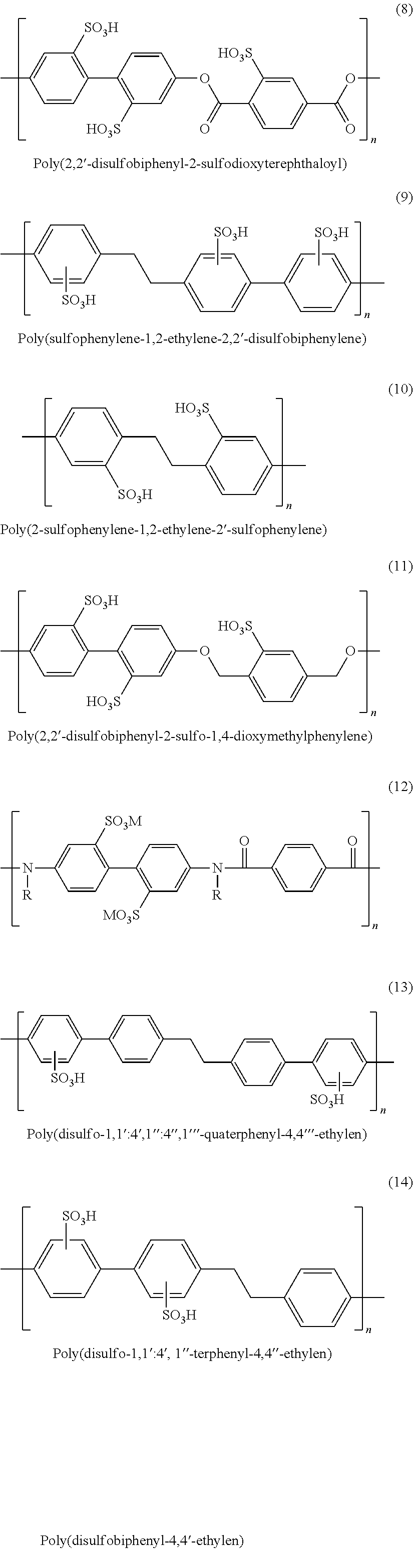 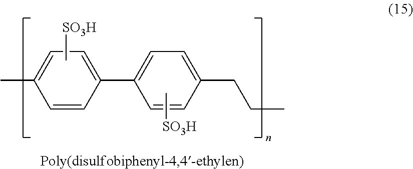 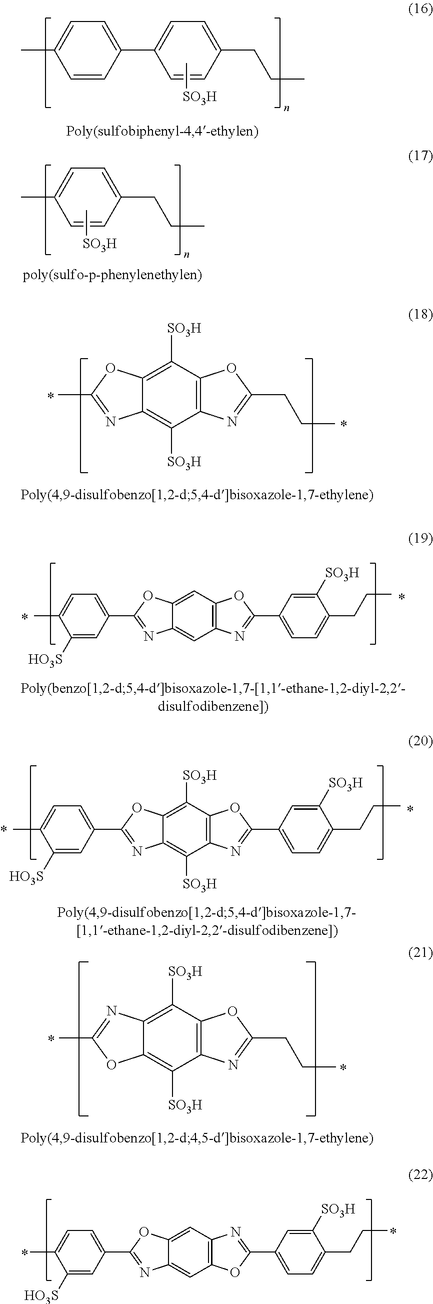 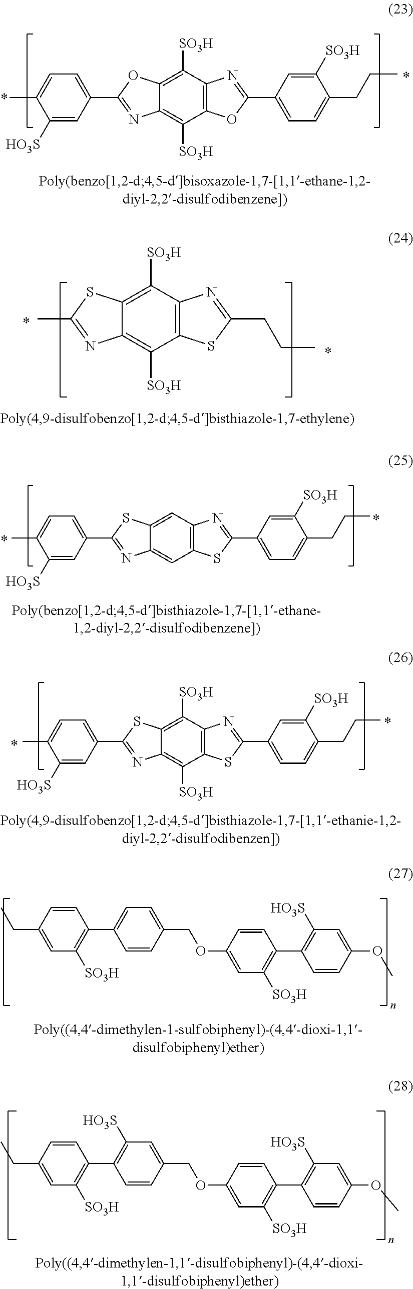 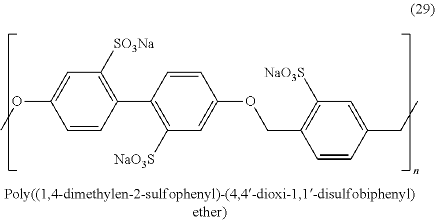
where R is a side-group selected from the list comprising Alkil, (CH₂)ₘSO₃H, (CH₂)ₘSi(O Alkyl)₃, CH₂Phenyl, (CH₂)ₘOH and M is counterion selected from the list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, Zr⁴⁺ and NH₄₋ₖQₖ⁺, where Q is selected from the list comprising linear and branched (C1-C20) alkyl, (C2-C20) alkenyl, (C2-C20) alkinyl, and (C6-C20)arylalkyl, and k is 0, 1, 2, 3 or 4.
